(19) United States
(12) Patent Application Publication
(10) Pub. No.: US 2004/0237399 A1
(43) Pub. Date: Dec. 2, 2004

(54) Floral wrapper with decorative portion and method

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/619,062

(22) Filed: Jul. 10, 2003

Related U.S. Application Data
(63) Continuation-in-part of application No. 10/446,500, filed on May 27, 2003.

(51) Int. Cl. A01G 9/02

(52) U.S. Cl. 47/72

(57) ABSTRACT

A wrapper for wrapping a flower pot and/or floral grouping or other item. The wrapper is constructed of a sheet of material having a central decorative portion and a peripheral decoration. When the wrapper is formed about a flower pot to form a decorative cover, the variation in the decoration of the wrapper provides the cover with at least a “two-sheet” effect which provides the cover with the appearance of being constructed of at least two or more separate sheets. The wrapper may also comprise a decorative extension or detachable portion.

### CROSS REFERENCE TO RELATED APPLICATIONS

The present application is a continuation-in-part of U.S. Ser. No. 10/446,500, filed May 27, 2003, the specification of which is hereby expressly incorporated by reference herein in its entirety.

### BACKGROUND

This invention generally relates to but is not limited to, wrappers used to wrap items, including floral groupings and/or media, or flower pots containing floral groupings and/or media, and methods of using same.

### DESCRIPTION OF THE DRAWINGS

FIG. 1 is an elevational view of a wrapper of the present invention.

FIG. 2 is a perspective view of the wrapper of FIG. 1 formed about a potted plant.

FIG. 3 is an elevational view of an alternate embodiment of the wrapper of the present invention.

FIG. 4 is an elevational view of an alternate embodiment of the wrapper of the present invention.

FIG. 5 is a perspective view of the wrapper of FIG. 4 formed about a potted plant.

FIG. 6 is an elevational view of an alternate embodiment of the wrapper of the present invention.

FIG. 7 is an elevational view of an alternate embodiment of the wrapper of the present invention.

FIG. 8 is a perspective view of the wrapper of FIG. 7 formed about a potted plant.

FIG. 9 is an elevational view of an alternate embodiment of the wrapper of the present invention.

FIG. 10 is an elevational view of an alternate embodiment of the wrapper of the present invention.

FIG. 11 is a perspective view of the wrapper of FIG. 10 formed about a potted plant.

FIG. 12 is an elevational view of an alternate embodiment of the wrapper of the present invention.

FIG. 13 is an elevational view of an alternate embodiment of the wrapper of the present invention.

FIG. 14 is a perspective view of the wrapper of FIG. 13 formed about a potted plant.

FIG. 15 is an elevational view of an alternate embodiment of the wrapper of the present invention.

FIG. 16 is an elevational view of an alternate embodiment of the wrapper of the present invention.

FIG. 17 is an elevational view of an alternate embodiment of the wrapper of the present invention.

FIG. 18 is a perspective view of a potted plant covered by the wrapper of FIG. 17.

FIG. 19 is an elevational view of an alternate embodiment of the wrapper of the present invention.

FIG. 20 is an elevational view of an alternate embodiment of the wrapper of the present invention.

FIG. 21 is a perspective view of a potted plant covered by the wrapper of FIG. 20.

FIG. 22 is an elevational view of another embodiment of the wrapper of the present invention.

FIG. 23 is an elevational view of another embodiment of the wrapper of the present invention.

FIG. 24 is a perspective view of the wrapper of FIG. 23 formed about a potted plant.

FIG. 25 is an elevational view of another embodiment of the wrapper of the present invention.

FIG. 26 is an elevational view of another embodiment of the wrapper of the present invention.

FIG. 27 is a perspective view of the wrapper of FIG. 26 formed about a potted plant.

FIG. 28 is an elevational view of another embodiment of the wrapper of the present invention.

FIG. 29 is an elevational view of another embodiment of the wrapper of the present invention.

FIG. 30 is a cross-sectional view of the wrapper of FIG. 29.

FIG. 31 is a perspective view of the wrapper of FIG. 29 formed about a potted plant.

FIG. 32 is a perspective view of the wrapper of the FIG. 1 used to wrap a basket.

FIG. 33 is a perspective view of a basket or container having a liner constructed of wrapper of the present invention.

FIG. 34 is a perspective view of a box or bag wherein a material constructed in accordance with the present invention is used as a filler for the box or bag.

### DETAILED DESCRIPTION OF THE INVENTION

The present invention is a wrapper (also referred to herein as a “decorative wrapper”) for decorating and covering flower pots, flower pots having floral groupings (plants) therein, floral groupings comprising cut flowers, corsages, floral groupings disposed in a “non-pot” floral holding material such as a foam or fiber block, and non-pot or non-plant items such as baskets, gifts, gift boxes, fruit or candy boxes, and other boxed or unboxed items including nuts, vegetables, plant bulbs, and comestibles. The wrappers contemplated herein could be used as a basket or box liner or as a decorative filler for a bag, gift bag, or box, rather than as a wrapper. The wrappers described herein could be used as a filler for a box or item to be shipped. Preferably, the wrapper contemplated herein comprises a single sheet of material having a cental decorative portion and a peripheral decoration which at least partially surrounds the central decorative portion, and which has a different decorative effect than a decorative effect of the central decorative portion. The wrapper described herein may be used also to produce a preformed pot cover, such as a Speed Cover™ formed for example by a mated mold system such as described in U.S. Pat. No. 4,773,182, which is hereby expressly incorporated by reference herein in its entirety.

In the present invention, when the wrapper is disposed about a potted plant, the decorative cover formed thereby has a decorative skirt or “ruffle” (also referred to herein as a skirt) which has a decorative effect which is different from a base portion of the wrapper. The decorative skirt provides the decorative cover with a layered appearance of being comprised of two (or more) separate and different “whole” or “entire” decorative sheets of material. Previously, in order to achieve this “two-sheet” appearance or effect, the user had to use two entire sheets of material, which were either separate or attached. If the sheets of material were separate, the user was required to obtain a first sheet of material then place a second sheet of material upon the first sheet of material then shift and move the second or first sheet about so as to achieve close or symmetric alignment of the edges of the sheets so as to provide a consistent and pleasing decorative effect of the two sheet cover when the combined two sheets of material were wrapped about a flower pot or other item. The process was even more difficult and time consuming when three or more sheets were used for obtaining a “three-sheet” (or more) appearance or layered effect. Further, the process of manually aligning separate sheets of material upon each other can be difficult due to the “dinginess” of polymer films.

The wrapper of the present invention therefore enables the user to obtain the same “two-sheet” appearance or layered effect as obtained with two entirely separate or different sheets of material but without the extra effort and difficulties of having to manually align the two sheets and, moreover, without the higher expense required by using two separate entire sheets. Users of the present invention not only benefit from increased ease and consistency of application, but also enjoy considerable cost savings due to the significantly reduced labor and material costs obtained by employing single sheets.

As noted above, the present invention contemplates in a preferred version a wrapper made of a decorative sheet of material having a peripheral decoration thereon, and which may have a straight or non-linear upper edge and/or a straight or non-linear lower edge. The sheet of material may further comprise a detachable upper portion which may be sized to surround and encompass the floral grouping disposed within the flower pot. The upper portion when present may be detachable via a detaching element, including but not limited to, perforations, tear strips, weakened areas, or zippers.

Also, the wrapper may comprise an adhesive or cohesive bonding material disposed on an inner surface thereof for bondingly connecting the wrapper to the pot or for connecting portions of the wrapper together after the wrapper has been disposed about the flower pot. Alternately, a bonding material may be disposed on an outer surface of the wrapper for securing a crimped portion having a plurality of crimped folds formed in the wrapper about the flower pot or floral grouping to secure the wrapper about the pot.

These embodiments and others of the present invention are now described in more detail below. It will be appreciated that the examples provided herein are not intended to limit the scope and extent of the claimed invention but are only intended to exemplify various embodiments of the invention contemplated herein.

Shown in FIG. 1 and designated therein by the general reference numeral 10 is a wrapper for forming a decorative cover about a flower pot and/or a floral grouping, or other items as described above and elsewhere herein. The wrapper 10 is constructed of a sheet of material 12 having a first surface 14, a second surface 16, an outer peripheral edge 18 comprising a first edge 20, a second edge 22, a third edge 24, and a fourth edge 46, a first length 28 extending between first edge 20 and second edge 22, and a second length 30 extending between the third edge 24 and the fourth edge 26. The wrapper 10 further comprises a central decorative portion 32 and a peripheral decoration 34 comprising a first portion 36 and a second portion 38. The central decorative portion 32 occupies a generally central position on the first surface 14 of the sheet of material 12 between the third edge 24 and the fourth edge 26 of the sheet of material 12 and the peripheral decoration 34. The first portion 36 of the peripheral decoration 34 occupies a position between the first edge 20, the third edge 24, the fourth edge 26, and the central decoration portion 32.

The second portion 38 of the peripheral decoration 34 occupies a position between the second edge 22, third edge 24, fourth edge 26 and central decorative portion 32. The first portion 36 of the peripheral decoration 34 comprises a first inner boundary 40 which demarcates the first portion 36 of the peripheral decoration 34 from the central decorative portion 32. The second portion 38 of the peripheral decoration 34 comprises a second inner boundary 42 which demarcates the second portion 38 of the peripheral decoration 34 from the central decorative portion 32. The central decorative portion 32 has a width 44 extending generally between the first inner boundary 40 and the second inner boundary 42. The first portion 36 of the peripheral decoration 34 has a width 46, and the second portion 38 of the peripheral decoration 34 has a width 48. Since the first inner boundary 40 and second inner boundary 42 may comprise an edge of a printed pattern, the first inner boundary 40 and second inner boundary 42 may be irregular, rather than straight or curved. When the first inner boundary 40 and/or the second inner boundary 42 are irregular, the point on the first inner boundary 40 or second inner boundary 42 from which the width 46 and width 48 are measured will be considered to be those portions of the first inner boundary 40 and second inner boundary 42 which extend the furthest into the central decorative portion 32. The central decorative portion 32 is understood to comprise a decoration which is different from the peripheral decoration 34, wherein the peripheral decoration 34 has the appearance of a sheet of material which is different and separate from the sheet of material from which the wrapper 10 having the central decorative portion 32 is constructed, thereby giving the wrapper 10 a “two-sheet effect” as discussed elsewhere herein when formed as a decorative cover about a pot, floral grouping or other item as described elsewhere herein, and as shown for example in FIG. 2.

FIG. 2 shows the wrapper 10 formed about a pot 50 and floral grouping 52 to provide a decorative cover 60 having a “two-sheet effect”, and secured about the pot 50 with a securing element 62. The first surface 14 of the wrapper 10 forms an outer surface 64 of the decorative cover 60. When the wrapper 10 is constructed from a sheet of material 12 having “dead-fold” properties, e.g., a metal foil, wherein the wrapper 10 readily holds its shape when folded or wrapped, it may not be necessary to secure the wrapper 10 about the pot 50 with a securing element 62. The central decorative portion 32 and the peripheral decoration 34 may comprise any decorative effect, such as a color, texture, pattern, or design, as long as the central decorative portion 32 has a decorative effect which is different from the decorative effect of the peripheral decoration 34 in at least one manner. For example, the colors of the central decorative portion 32 and the peripheral decoration 34 may be the same, but the pattern or design printed thereon may be different. Alternatively, the pattern or design may be the same, but the colors may be different. Alternatively, the colors and patterns or designs may be the same, but the textures may be different, for example.

In one embodiment, the decorative pattern or effect of the central decorative portion 32 may be visible on or through only one, or both, of the first surface 14 and the second surface 16. Further, the decorative pattern or effect of the peripheral decoration 34 may be visible on or through only one, or both, of the first surface 14 and the second surface 16 (for example, the latter is shown in FIG. 2). Alternatively, the decorative pattern or effect of the central decorative portion 32 may be visible on or through both of the first surface 14 and the second surface 16, while the decorative pattern or effect of the peripheral decoration is visible on only one of the first surface 14 or second surface 16. Further, the decorative pattern or effect of the peripheral decoration 34 may be visible on or through both of the first surface 14 and second surface 16, wherein the decorative pattern or effect of the central decorative portion 32 is visible on only one of the first surface 14 or second surface 16. All of these arrangements are intended to enhance the “two-sheet effect” or multi-sheet appearance as described elsewhere herein.

The width 46 of the first portion 36 of the peripheral decoration 34 and the width 48 of the second portion 38 of the peripheral decoration 34 are each preferably from about 5% to about 50% of the width 44 of the central decorative portion 32, more preferably from about 10% to about 40%, more preferably from about 15% to about 35% and, more preferably from about 20% to about 30%.

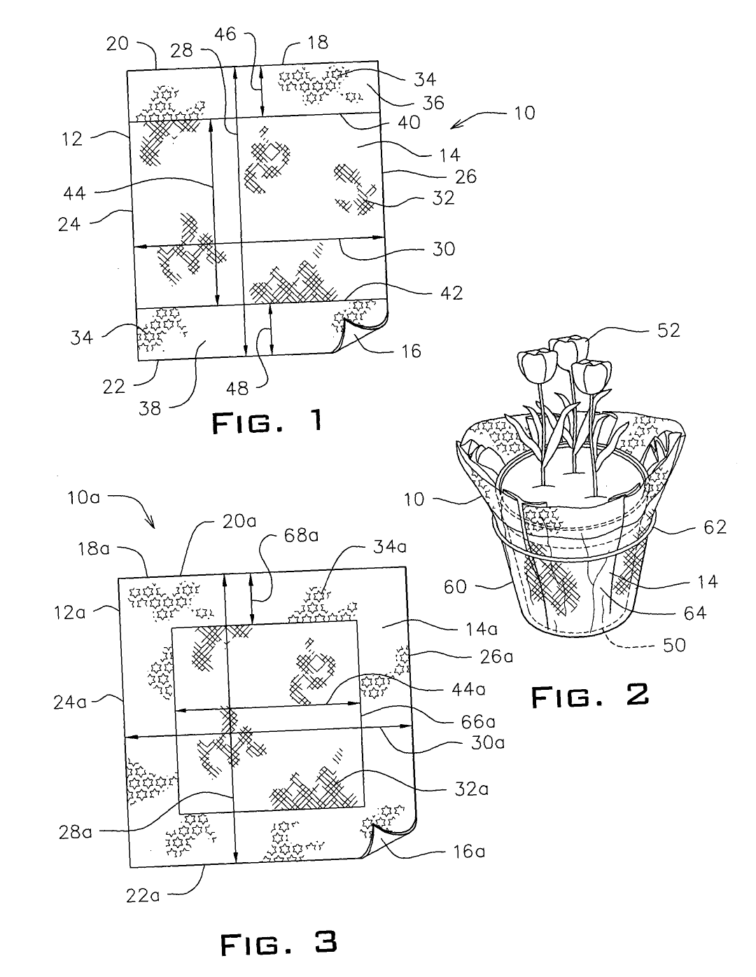

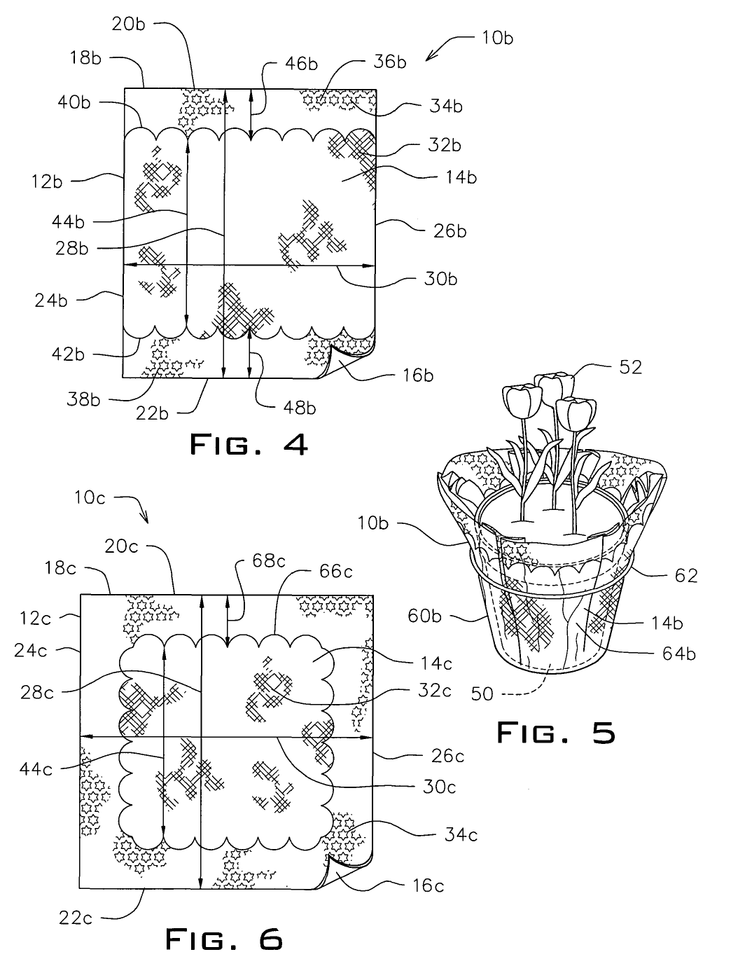

Shown in FIG. 3 and designated therein by the general reference numeral 10a is a wrapper for forming a decorative cover about a flower pot and/or a floral grouping, or other items as described above and elsewhere herein. Wrapper 10a is generally similar to wrapper 10 of FIG. 1 except for the differences described herein. The wrapper 10a is constructed of a sheet of material 12a having a first surface 14a, a second surface 16a, an outer peripheral edge 18a comprising a first edge 20a, a second edge 22a, a third edge 24a, and a fourth edge 26a, a first length 28a extending between first edge 20a and second edge 22a, and a second length 30a extending between the third edge 24a and the fourth edge 26a. The wrapper 10a further comprises a central decorative portion 32a and a peripheral decoration 34a having an inner boundary 66a located a length 68a inwardly from the outer peripheral edge 18a. The central decorative portion 32a occupies a generally central position on the first surface 14a of the sheet of material 12a inside the inner boundary 66a of the peripheral decoration 34a. The peripheral decoration 34a generally forms a complete border about the central decorative portion 32a.

The central decorative portion 32a has a width 44a extending thereacross generally across opposite portions of the inner boundary 66a of the peripheral decoration 34a. The peripheral decoration 34a also has a width 68a, extending between the outer peripheral edge 18a and the inner boundary 66a. The inner boundary 66a may be irregular, rather than straight or curved. When the inner boundary 66a is irregular, the point on the inner boundary 66a from which the width 68a is measured will be considered to be that portion of the inner boundary 66a which extends the furthest into the central decorative portion 32a. The central decorative portion 32a is understood to comprise a decoration which is different from the peripheral decoration 34a, wherein the peripheral decoration 34a has the appearance of a sheet of material which is different from the sheet of material from which the wrapper 10a having the central decorative portion 32a is constructed, thereby giving the wrapper 10a a “two-sheet effect” as discussed elsewhere herein when formed about a pot, floral grouping or other item as described elsewhere herein, in a manner shown, for example for decorative cover 60 in FIG. 2.

When the wrapper 10a is constructed from a material having “dead-fold” properties, e.g., a metal foil, wherein the wrapper 10a readily holds its shape when folded or wrapped, it may not be necessary to secure the wrapper 10a about a pot with a securing element. The central decorative portion 32a and the peripheral decoration 34a may comprise any decorative effect, such as a color, texture, pattern, or design, as long as the central decorative portion 32a has a decorative effect which is different from the decorative effect of the peripheral decoration 34a in at least one manner. For example, the colors of the central decorative portion 32a and the peripheral decoration 34a may be the same, but the pattern or design printed thereon may be different. Alternatively, the pattern or design may be the same, but the colors may be different. Alternatively, the colors and patterns or designs may be the same, but the textures may be different, for example.

The width 68a of the peripheral decoration 34a is preferably from about 5% to about 50% of the width 44a of the central decorative portion 32a, more preferably from about 10% to about 40%, more preferably from about 15% to about 35% and, more preferably from about 20% to about 30%.

Shown in FIG. 4 and designated therein by the general reference numeral 10b is a wrapper for forming a decorative cover about a flower pot and/or a floral grouping, or other items as described above and elsewhere herein. The wrapper 10b is constructed of a sheet of material 12b having a first surface 14b, a second surface 16b, an outer peripheral edge 18b comprising a first edge 20b, a second edge 22b, a third edge 24b, and a fourth edge 26b, a first length 28b extending between first edge 20b and second edge 22b, and a second length 30b extending between the third edge 24b and the fourth edge 26b. The wrapper 10b further comprises a central decorative portion 32b and a peripheral decoration 34b comprising a first portion 36b and a second portion 38b. The central decorative portion 32b occupies a generally central position on the first surface 14b of the sheet of material 12b between the third edge 24b and the fourth edge 26b of the sheet of material 12b and the peripheral decoration 34b. The first portion 36b of the peripheral decoration 34b occupies a position between the first edge 20b, the second edge 24b, the fourth edge 26b, and the central decoration portion 32b.

The second portion 38b of the peripheral decoration 34b occupies a position between the second edge 22b, third edge 24b, fourth edge 26b and central decorative portion 32b. The first portion 36b of the peripheral decoration 34b comprises a first inner boundary 40b which demarcates the first portion 36b of the peripheral decoration 34b from the central decorative portion 32b. The second portion 38b of the peripheral decoration 34b comprises a second inner boundary 42b which demarcates the second portion 38b of the peripheral decoration 34b from the central decorative portion 32b. The central decorative portion 32b has a width 44b extending generally between the first inner boundary 40b and the second inner boundary 42b. The first portion 36b of the peripheral decoration 34b has a width 46b, and the second portion 38b of the peripheral decoration 34b has a width 48b. Since the first inner boundary 40b and second inner boundary 42b may comprise an edge of a printed pattern, the first inner boundary 40b and second inner boundary 42b may be irregular, rather than straight or curved. When the first inner boundary 40b and/or the second inner boundary 42b are irregular, the point on the first inner boundary 40b or second inner boundary 42b from which the width 46b and width 48b are measured will be considered to be those portions of the first inner boundary 40b and second inner boundary 42b which extend furthest into the central decorative portion 32b. The central decorative portion 32b is understood to comprise a decoration which is different from the peripheral decoration 34b, wherein the peripheral decoration 34b has the appearance of a sheet of material which is different and separate from the sheet of material from which the wrapper 10b having the central decorative portion 32b is constructed, thereby giving the wrapper 10b a “two-sheet effect” as discussed elsewhere herein when formed as a decorative cover about a pot, floral grouping or other item as described elsewhere herein, and as shown for example in FIG. 5. Wrapper 10b differs from wrapper 10 primarily in that inner boundary 40b and 42b have a generally non-linear pattern.

FIG. 5 shows the wrapper 10b formed about pot 50 and floral grouping 52 to provide a decorative cover 60b having a “two-sheet effect”, and secured about the pot 50 with a securing element 62. The first surface 14b of the wrapper 10b forms an outer surface 64b of the decorative cover 60b. When the wrapper 10b is constructed from a sheet of material 12b having “dead-fold” properties, e.g., a metal foil, wherein the wrapper 10b readily holds its shape when folded or wrapped, it may not be necessary to secure the wrapper 10b about the pot 50 with a securing element 62. The central decorative portion 32b and the peripheral decoration 34b may comprise any decorative effect, such as a color, texture, pattern, or design, as long as the central decorative portion 32b has a decorative effect which is different from the decorative effect of the peripheral decoration 34b in at least one manner. For example, the colors of the central decorative portion 32b and the peripheral decoration 34b may be the same, but the pattern or design printed thereon may be different. Alternatively, the pattern or design may be the same, but the colors may be different. Alternatively, the colors and patterns or designs may be the same, but the textures may be different, for example.

The width 46b of the first portion 40b of the peripheral decoration 34b and the width 48b of the second portion 42b of the peripheral decoration 34b are each preferably from about 5% to about 50% of the width 44b of the central decorative portion 32b, more preferably from about 10% to about 40%, more preferably from about 15% to about 35% and, more preferably from about 20% to about 30%.

Shown in FIG. 6 and designated therein by the general reference numeral 10c is a wrapper for forming a decorative cover about a flower pot and/or a floral grouping, or other items as described above and elsewhere herein. Wrapper 10c is generally similar to wrapper 10a of FIG. 3 except for the differences described herein. The wrapper 10c is constructed of a sheet of material 12c having a first surface 14c, a second surface 16c, an outer peripheral edge 18c comprising a first edge 20c, a second edge 22c, a third edge 24c, and a fourth edge 26c, a first length 28c extending between first edge 20c and second edge 22c, and a second length 30c extending between the third edge 24c and the fourth edge 26c. The wrapper 10c further comprises a central decorative portion 32c and a peripheral decoration 34c having an inner boundary 66c located a length 68c inwardly from the outer peripheral edge 18c. The central decorative portion 32c occupies a generally central position on the first surface 14c of the sheet of material 12c inside the inner boundary 66c of the peripheral decoration 34c. The peripheral decoration 34c generally forms a complete border about the central decorative portion 32c. Inner boundary 66c has a generally non-linear pattern.

The central decorative portion 32c has a width 44c extending thereacross generally across opposite portions of the inner boundary 66c of the peripheral decoration 34c. The peripheral decoration 34c also has a width 68c, extending between the outer peripheral edge 18c and the inner boundary 66c. The inner boundary 66c may be irregular, rather than straight or curved. When the inner boundary 66c is irregular, the point on the inner boundary 66c from which the width 68c is measured will be considered to be that portion of the inner boundary 66c which extends the furthest into the central decorative portion 32c. The central decorative portion 32c is understood to comprise a decoration which is different from the peripheral decoration 34c, wherein the peripheral decoration 34c has the appearance of a sheet of material which is different from the sheet of material from which the wrapper 10c having the central decorative portion 32c is constructed, thereby giving the wrapper 10c a “two-sheet effect” as discussed elsewhere herein when formed about a pot, floral grouping or other item as described elsewhere herein, in a manner shown, for example for decorative cover 60b in FIG. 5.

When the wrapper 10c is constructed from a material having “dead-fold” properties, e.g., a metal foil, wherein the wrapper 10c readily holds its shape when folded or wrapped, it may not be necessary to secure the wrapper 10c about a pot with a securing element. The central decorative portion 32c and the peripheral decoration 34c may comprise any decorative effect, such as a color, texture, pattern, or design, as long as the central decorative portion 32c has a decorative effect which is different from the decorative effect of the peripheral decoration 34c in at least one manner. For example, the colors of the central decorative portion 32c and the peripheral decoration 34c may be the same, but the pattern or design printed thereon may be different. Alternatively, the pattern or design may be the same, but the colors may be different. Alternatively, the colors and patterns or designs may be the same, but the textures may be different, for example.

The width 68c of the peripheral decoration 34c is preferably from about 5% to about 50% of the width 44c of the central decorative portion 32c, more preferably from about 10% to about 40%, more preferably from about 15% to about 35% and, more preferably from about 20% to about 30%.

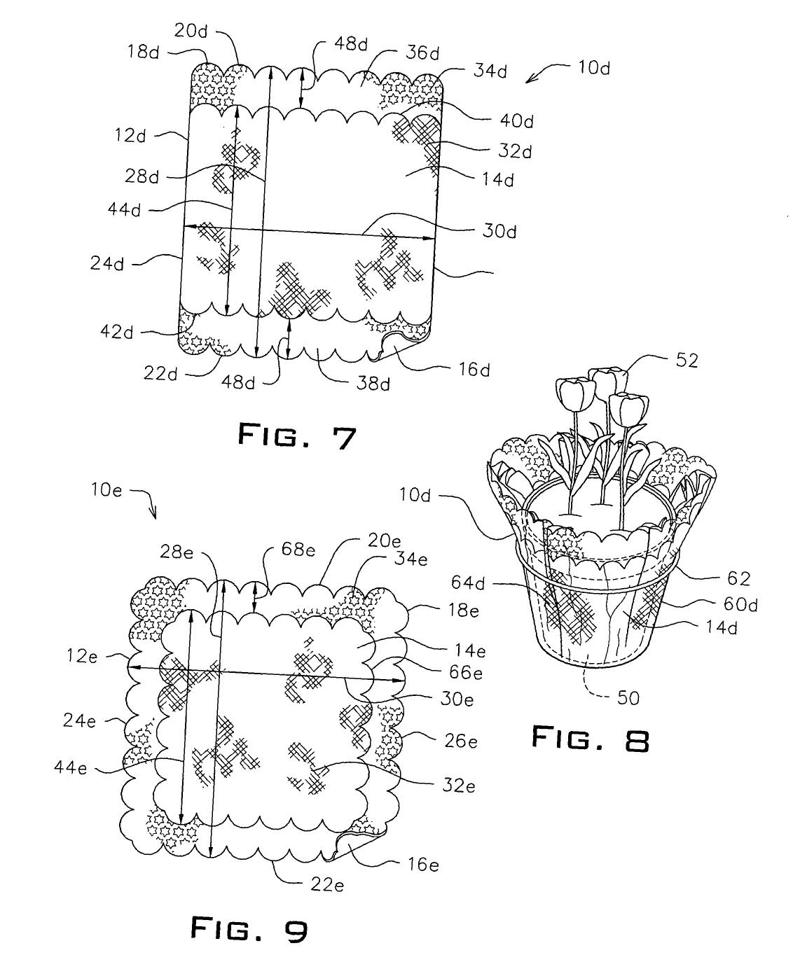

Shown in FIG. 7 and designated therein by the general reference numeral 10d is a wrapper for forming a decorative cover about a flower pot and/or a floral grouping, or other items as described above and elsewhere herein. Wrapper 10d is generally similar to wrapper 10b except for the differences described herein. The wrapper 10d is constructed of a sheet of material 12d having a first surface 14d, a second surface 16d, an outer peripheral edge 18d comprising a first edge 20d, a second edge 22d, a third edge 24d, and a fourth edge 26d, a first length 28d extending between first edge 20d and second edge 22d, and a second length 30d extending between the third edge 24d and the fourth edge 26d. The wrapper 10d further comprises a central decorative portion 32d and a peripheral decoration 34d comprising a first portion 36d and a second portion 38d. The central decorative portion 32d occupies a generally central position on the first surface 14d of the sheet of material 12d between the third edge 24d and the fourth edge 26d of the sheet of material 12d and the peripheral decoration 34d. The first portion 36d of the peripheral decoration 34d occupies a position between the first edge 20d, the third edge 24d, the fourth edge 26d, and the central decoration portion 32d.

The second portion 38d of the peripheral decoration 34d occupies a position between the second edge 22d, third edge 24d, fourth edge 26d and central decorative portion 32d. The first portion 36d of the peripheral decoration 34d comprises a first inner boundary 40d which demarcates the first portion 36d of the peripheral decoration 34d from the central decorative portion 32d. Both the first edge 20d and the first inner boundary 40d have non-linear patterns. The second portion 38d of the peripheral decoration 34d comprises a second inner boundary 42d which demarcates the second portion 38d of the peripheral decoration 34d from the central decorative portion 32d. Both the second edge 22d and second inner boundary 42d have non-linear patterns. The central decorative portion 32d has a width 44d extending generally between the first inner boundary 40d and the second inner boundary 42d. The first portion 36d of the peripheral decoration 34d has a width 46d, and the second portion 38d of the peripheral decoration 34d has a width 48d. The width 46d and width 48d are defined as the widest portions of the first inner boundary 40d and second inner boundary 42d, respectively. The central decorative portion 32d is understood to comprise a decoration which is different from the peripheral decoration 34d, wherein the peripheral decoration 34d has the appearance of a sheet of material which is different and separate from the sheet of material from which the wrapper 10d having the central decorative portion 32d is constructed, thereby giving the wrapper 10d a “two-sheet effect” as discussed elsewhere herein when formed as a decorative cover about a pot, floral grouping or other item as described elsewhere herein, and as shown for example in FIG. 8.

FIG. 8 shows the wrapper 10d formed about pot 50 and floral grouping 52 to provide a decorative cover 60d having a “two-sheet effect”, and secured about the pot 50 with a securing element 62. The first surface 14d of the wrapper 10d forms an outer surface 64d of the decorative cover 60d. When the wrapper 10d is constructed from a material having “dead-fold” properties, e.g., a metal foil, wherein the wrapper 10d readily holds its shape when folded or wrapped, it may not be necessary to secure the wrapper 10d about the pot 50 with a securing element 62. The central decorative portion 32d and the peripheral decoration 34d may comprise any decorative effect, such as a color, texture, pattern, or design, as long as the central decorative portion 32d has a decorative effect which is different from the decorative effect of the peripheral decoration 34d in at least one manner. For example, the colors of the central decorative portion 32d and the peripheral decoration 34d may be the same, but the pattern or design printed thereon may be different. Alternatively, the pattern or design may be the same, but the colors may be different. Alternatively, the colors and patterns or designs may be the same, but the textures may be different, for example.

The width 46d of the first portion 36d of the peripheral decoration 34d and the width 48d of the second portion 38d of the peripheral decoration 34d are each preferably from about 5% to about 50% of the width 44d of the central decorative portion 32, more preferably from about 10% to about 40%, more preferably from about 15% to about 35% and, more preferably from about 20% to about 30%.

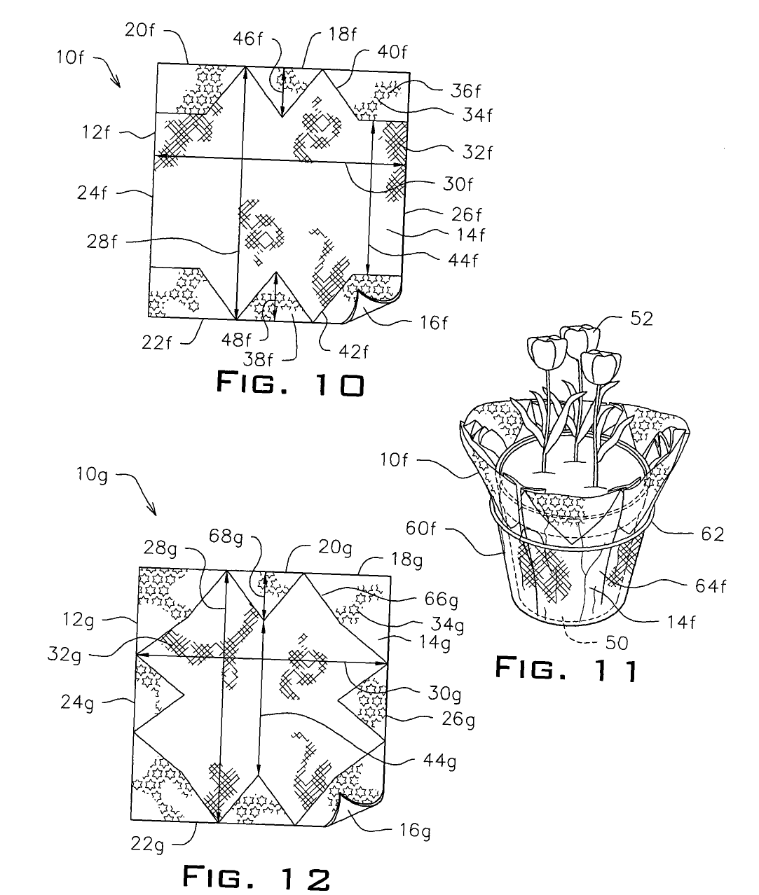

Shown in FIG. 9 and designated therein by the general reference numeral 10e is a wrapper for forming a decorative cover about a flower pot and/or a floral grouping, or other items as described above and elsewhere herein. Wrapper 10e is generally similar to wrapper 10c of FIG. 6 except for the differences described herein. The wrapper 16e is constructed of a sheet of material 12e having a first surface 14e, a second surface 16e, an outer peripheral edge 18e comprising a first edge 20e, a second edge 22e, a third edge 24e, and a fourth edge 26e, a first length 28e extending between first edge 20e and second edge 22e, and a second length 30e extending between the third edge 24e and the fourth edge 26e. The wrapper 10e further comprises a central decorative portion 32e and a peripheral decoration 34e having an inner boundary 66e located a length 68e inwardly from the outer peripheral edge 18e. The central decorative portion 32e occupies a generally central position on the first surface 14c of the sheet of material 12e inside the inner boundary 66e of the peripheral decoration 34e. The peripheral decoration 34e generally forms a complete border about the central decorative portion 32e.

The central decorative portion 32e has a width 44e extending thereacross generally across opposite portions of the inner boundary 66e of the peripheral decoration 34e. The peripheral decoration 34e also has a width 68e, extending between the outer peripheral edge 18e and the inner boundary 66e. The inner boundary 66a has an irregular, or non-linear pattern, as does the outer peripheral edge 18e. The width 68e is defined as the widest portion of the inner boundary 66e. The central decorative portion 32e is understood to comprise a decoration which is different from the peripheral decoration 34e, wherein the peripheral decoration 34e has the appearance of a sheet of material which is different from the sheet of material from which the wrapper 10e having the central decorative portion 32e is constructed, thereby giving the wrapper 10e a “two-sheet effect” as discussed elsewhere herein when formed about a pot, floral grouping or other item as described elsewhere herein, in a manner shown, for example for decorative cover 60d in FIG. 8.

When the wrapper 10e is constructed from a material having “dead-fold” properties, e.g., a metal foil, wherein the wrapper 10e readily holds its shape when folded or wrapped, it may not be necessary to secure the wrapper 10e about a pot with a securing element. The central decorative portion 32e and the peripheral decoration 34e may comprise any decorative effect, such as a color, texture, pattern, or design, as long as the central decorative portion 32e has a decorative effect which is different from the decorative effect of the peripheral decoration 34e in at least one manner. For example, the colors of the central decorative portion 32e and the peripheral decoration 34e may be the same, but the pattern or design printed thereon may be different. Alternatively, the pattern or design may be the same, but the colors may be different. Alternatively, the colors and patterns or designs may be the same, but the textures may be different, for example.

The width 68e of the peripheral decoration 34e is preferably from about 5% to about 50% of the width 44e of the central decorative portion 32e, more preferably from about 10% to about 40%, more preferably from about 15% to about 35% and, more preferably from about 20% to about 30%.

Shown in FIG. 10 and designated therein by the general reference numeral 10f is a wrapper for forming a decorative cover about a flower pot and/or a floral grouping, or other items as described above and elsewhere herein. The wrapper 10f is similar to wrapper 10 of FIG. 1 except for the differences described herein. The wrapper 10f is constructed of a sheet of material 12f having a first surface 14f, a second surface 16f, an outer peripheral edge 18f comprising a first edge 20f, a second edge 22f, a third edge 24f, and a fourth edge 26f, a first length 28f extending between first edge 20f and second edge 22f, and a second length 30f extending between the third edge 24f and the fourth edge 26f. The wrapper 10 further comprises a central decorative portion 32f and a peripheral decoration 34f comprising a first portion 36f and a second portion 38f. The central decorative portion 32f occupies a generally central position on the first surface 14f of the sheet of material 12f between the third edge 24f and the fourth edge 26f of the sheet of material 12f and the peripheral decoration 34f. The first portion 36f of the peripheral decoration 34f occupies a position between the first edge 20f, the third edge 24f, the fourth edge 26f, and the central decoration portion 32f.

The second portion 38f of the peripheral decoration 34f occupies a position between the second edge 22f, third edge 24f, fourth edge 26f and central decorative portion 32f. The first portion 36f of the peripheral decoration 34f comprises a first inner boundary 40f which demarcates the first portion 36f of the peripheral decoration 34f from the central decorative portion 32f. The second portion 38f of the peripheral decoration 34f comprises a second inner boundary 42f which demarcates the second portion 38f of the peripheral decoration 34f from the central decorative portion 32f. The central decorative portion 32f has a width 44f which extends and is measured generally between the first inner boundary 40f and the second inner boundary 42f at its most narrow position. The first portion 36f of the peripheral decoration 34f has a width 46f, and the second portion 38f of the peripheral decoration 34f has a width 48f. The first inner boundary 40f and second inner boundary 42f each comprise an angular pattern. The central decorative portion 32f is understood to comprise a decoration which is different from the peripheral decoration 34f, wherein the peripheral decoration 34f has the appearance of a sheet of material which is different and separate from the sheet of material from which the wrapper 10f having the central decorative portion 32f is constructed, thereby giving the wrapper 10f a “two-sheet effect” as discussed elsewhere herein when formed as a decorative cover about a pot, floral grouping or other item as described elsewhere herein, and as shown for example in FIG. 11.

FIG. 11 shows the wrapper 10f formed about pot 50 and floral grouping 52 to provide a decorative cover 60f having a “two-sheet effect”, and secured about the pot 50 with a securing element 62. The first surface 14f of the wrapper 10f forms an outer surface 64f of the decorative cover 60f. When the wrapper 10f is constructed from a material having “dead-fold” properties, e.g., a metal foil, wherein the wrapper 10f readily holds its shape when folded or wrapped, it may not be necessary to secure the wrapper 10f about the pot 50 with a securing element 62. The central decorative portion 32f and the peripheral decoration 34f may comprise any decorative effect, such as a color, texture, pattern, or design, as long as the central decorative portion 32f has a decorative effect which is different from the decorative effect of the peripheral decoration 34f in at least one manner. For example, the colors of the central decorative portion 32f and the peripheral decoration 34f may be the same, but the pattern or design printed thereon may be different. Alternatively, the pattern or design may be the same, but the colors may be different. Alternatively, the colors and patterns or designs may be the same, but the textures may be different, for example.

The width 46f of the first portion 36f of the peripheral decoration 34f and the width 48f of the second portion 38f of the peripheral decoration 34f are each preferably from about 5% to about 50% of the width 44f of the central decorative portion 32f, more preferably from about 10% to about 40%, more preferably from about 15% to about 35% and, more preferably from about 20% to about 30%.

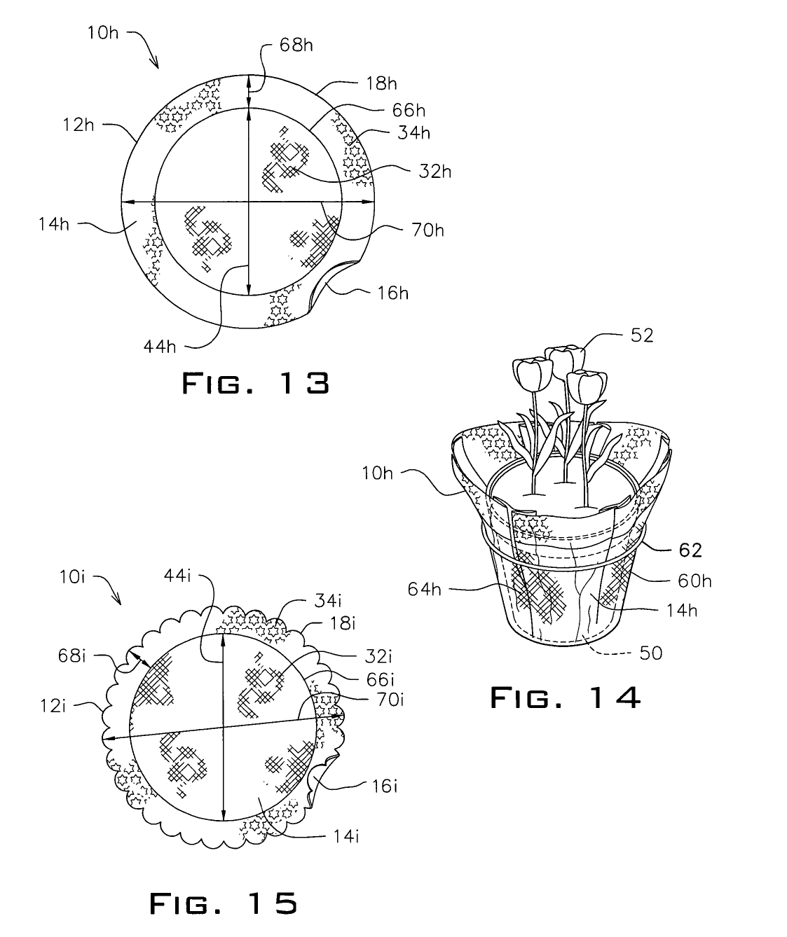

Shown in FIG. 12 and designated therein by the general reference numeral 10g is a wrapper for forming a decorative cover about a flower pot and/or a floral grouping, or other items as described above and elsewhere herein. Wrapper 10g is generally similar to wrapper 10f of FIG. 10 except for the differences described herein. The wrapper 10g is constructed of a sheet of material 12g having a first surface 14g, a second surface 16g, an outer peripheral edge 18g comprising a first edge 20g, a second edge 22g, a third edge 24g, and a fourth edge 26g, a first length 28g extending between first edge 20g and second edge 22g, and a second length 30g extending between the third edge 24g and the fourth edge 26g. The wrapper 10g further comprises a central decorative portion 32g and a peripheral decoration 34g having an inner boundary 66g located a distance inwardly from the outer peripheral edge 18g. The central decorative portion 32g occupies a generally central position on the first surface 14g of the sheet of material 12g inside the inner boundary 66g of the peripheral decoration 34g. The peripheral decoration 34g generally forms a complete border about the central decorative portion 32g. The inner boundary 66g comprises a pattern similar to the pattern of inner boundary 40f of wrapper 10f except inner boundary 66g extends entirely within the entire outer peripheral edge 18g of wrapper 10g.

The central decorative portion 32g has a width 44g and is defined as the narrowest distance across the inner boundary 66g of the peripheral decoration 34g. The peripheral decoration 34g also has a width 68g, extending between the widest portion of the outer peripheral edge 18g and the inner boundary 66g. The inner boundary 66g has a generally angular pattern. The central decorative portion 32g is understood to comprise a decoration which is different from the peripheral decoration 34g, wherein the peripheral decoration 34g has the appearance of a sheet of material which is different from the sheet of material from which the wrapper 10g having the central decorative portion 32g is constructed, thereby giving the wrapper log a “two-sheet effect” as discussed elsewhere herein when formed about a pot, floral grouping or other item as described elsewhere herein, in a manner shown, for example for decorative cover 60f in FIG. 11.

When the wrapper 10g is constructed from a material having “dead-fold” properties, e.g., a metal foil, wherein the wrapper 10g readily holds its shape when folded or wrapped, it may not be necessary to secure the wrapper 10g about a pot with a securing element. The central decorative portion 32g and the peripheral decoration 34g may comprise any decorative effect, such as a color, texture, pattern, or design, as long as the central decorative portion 32g has a decorative effect which is different from the decorative effect of the peripheral decoration 34g in at least one manner. For example, the colors of the central decorative portion 32g and the peripheral decoration 34g may be the same, but the pattern or design printed thereon may be different. Alternatively, the pattern or design may be the same, but the colors may be different. Alternatively, the colors and patterns or designs may be the same, but the textures may be different, for example.

The width 68g of the peripheral decoration 34g is preferably from about 5% to about 50% of the width 44g of the central decorative portion 32g, more preferably from about 10% to about 40%, more preferably from about 15% to about 35% and, more preferably from about 20% to about 30%.

Shown in FIG. 13 and designated therein by the general reference numeral 10h is a wrapper for forming a decorative cover about a flower pot and/or a floral grouping, or other items as described above and elsewhere herein. The wrapper 10h is similar to wrapper 10a of FIG. 3 except that the wrapper 10h has a circular or oval shape rather than a square or rectangular shape. The wrapper 10h is constructed of a sheet of material 12h having a first surface 14, a second surface 16h, an outer peripheral edge 18h and a diameter 70h extending across the first surface 14h. The wrapper 10h further comprises a central decorative portion 32h and a peripheral decoration 34h. The central decorative portion 32h occupies a generally central position on the first surface 14h of the sheet of material 12h inside of the peripheral decoration 34h.

The peripheral decoration 34h comprises an inner boundary 66h which demarcates the peripheral decoration 34h from the central decorative portion 32h. The central decorative portion 32h has a width 44h comprising a diameter thereof. The peripheral decoration 34h has a width 68h. Since the inner boundary 66h may comprise an edge of a printed pattern, the inner boundary 66h from which the width 68h is measured will be considered to be that portion of the inner boundary 66h which extends the furthest into the central decorative portion 32h. The central decorative portion 32h is understood to comprise a decoration which is different from the peipheral decoration 34h, wherein the peripheral decoration 34h has the appearance of a sheet of material which is different and separate from the sheet of material from which the wrapper 10h having the central decorative portion 32h is constructed, thereby giving the wrapper 10h a “two-sheet effect” as discussed elsewhere herein when formed as a decorative cover about a pot, floral grouping or other item as described elsewhere herein, and as shown for example in FIG. 14.

FIG. 14 shows the wrapper 10h formed about a pot 50 and floral grouping 52 to provide a decorative cover 60h having a “two-sheet effect”, and secured about the pot 50 with a securing element 62. The first surface 14h of the wrapper 10h forms an outer surface 64h of the decorative cover 60h. When the wrapper 10h is constructed from a material 12h having “dead-fold” properties, e.g., a metal foil, wherein the wrapper 10h readily holds its shape when folded or wrapped, it may not be necessary to secure the wrapper 10h about the pot 50 with a securing element 62h. The central decorative portion 32h and the peripheral decoration 34h may comprise any decorative effect, such as a color, texture, pattern, or design, as long as the central decorative portion 32h has a decorative effect which is different from the decorative effect of the peripheral decoration 34h in at least one manner. For example, the colors of the central decorative portion 32h and the peripheral decoration 34h may be the same, but the pattern or design printed thereon may be different. Alternatively, the pattern or design may be the same, but the colors may be different. Alternatively, the colors and patterns or designs may be the same, but the textures may be different, for example.

The width 68h of the peripheral decoration 34h and is preferably from about 5% to about 50% of the width 44h of the central decorative portion 32h, more preferably from about 10% to about 40%, more preferably from about 15% to about 35% and, more preferably from about 20% to about 30%.

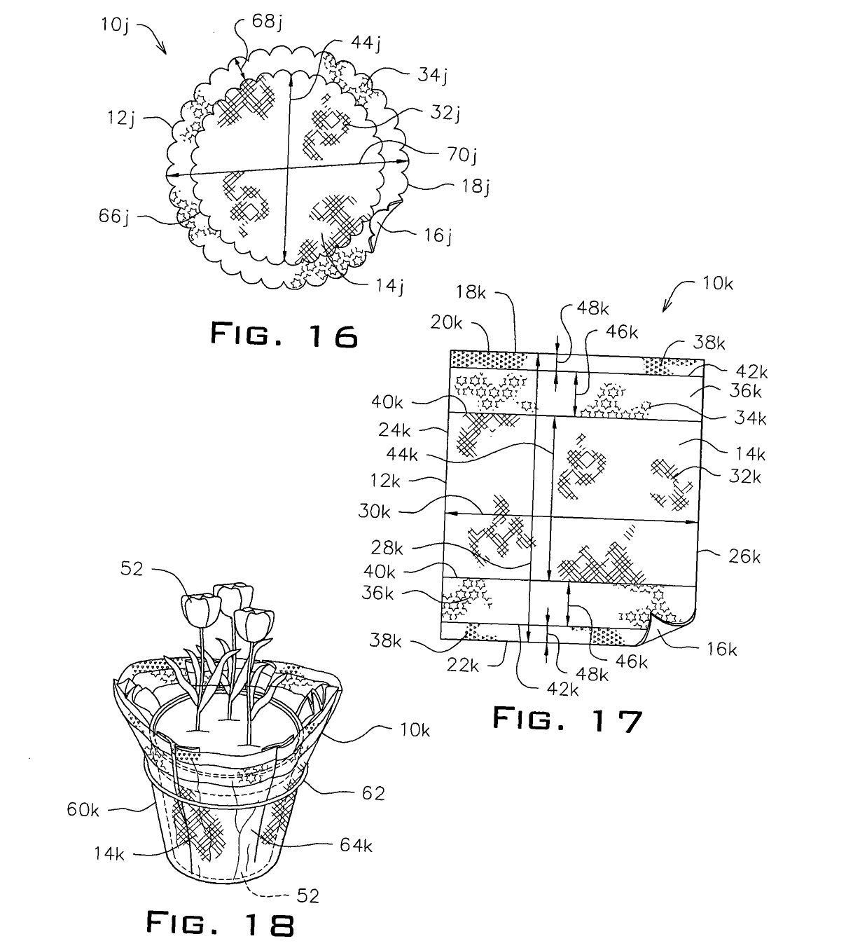

Shown in FIG. 15 and designated therein by the general reference numeral 10i is a wrapper for forming a decorative cover about a flower pot and/or a floral grouping, or other items as described above and elsewhere herein. Wrapper 10i is generally similar to wrapper 10h of FIG. 13 except for the differences described herein. The wrapper 10i is constructed of a sheet of material 12i having a first surface 14i, a second surface 16i, and an outer peripheral edge 18i having a non-linear pattern, such as a curved or scalloped pattern, or an irregular pattern. The wrapper 10i further comprises a central decorative portion 32i and a peripheral decoration 34i having an inner boundary 66i located a length 68i inwardly from the outer peripheral edge 18i. The central decorative portion 32i occupies a generally central position on the first surface 14i of the sheet of material 12i inside the inner boundary of the peripheral decoration 34i. The peripheral decoration 34i generally forms a complete border about the central decorative portion 32i.

The central decorative portion 32i has a width 44i extending thereacross generally across opposite portions of the inner boundary 66i of the peripheral decoration 34i. The peripheral decoration 34i also has a width 68i, extending between the outer peripheral edge 18i and the inner boundary 66i. The inner boundary 66i may be irregular, rather than curved. When the inner boundary 66i is irregular, the point on the inner boundary 66i from which the width 68i is measured will be considered to be that portion of the inner boundary 66i which extends the furthest into the central decorative portion 32i. The central decorative portion 32i is understood to comprise a decoration which is different from the peripheral decoration 34i, wherein the peripheral decoration 34i has the appearance of a sheet of material which is different from the sheet of material from which the wrapper 10i having the central decorative portion 32i is constructed, thereby giving the wrapper 10i a “two-sheet effect” as discussed elsewhere herein when formed about a pot, floral grouping or other item as described elsewhere herein, in a manner shown, for example for decorative cover 60h in FIG. 14.

When the wrapper 10i is constructed from a material having “dead-fold” properties, e.g., a metal foil, wherein the wrapper 10i readily holds its shape when folded or wrapper, it may not be necessary to secure the wrapper 10i about a pot with a securing element. The central decorative portion 32i and the peripheral decoration 34i may comprise any decorative effect, such as a color, texture, pattern, or design, as long as the central decorative portion 32i has a decorative effect which is different from the decorative effect of the peripheral decoration 34i in at least one manner. For example, the colors of the central decorative portion 32i and the peripheral decoration 34i may be the same, but the pattern or design printed thereon may be different. Alternatively, the pattern or design may be the same, but the colors may be different. Alternatively, the colors and patterns or designs may be the same, but the textures may be different, for example.

The width 68i of the peripheral decoration 34i is preferably from about 5% to about 50% of the width 44i of the central decorative portion 32i, more preferably from about 10% to about 40%, more preferably from about 15% to about 35% and, more preferably from about 20% to about 30%.

Shown in FIG. 16 and designated therein by the general reference numeral 10j is a wrapper for forming a decorative cover about a flower pot and/or a floral grouping, or other items as described above and elsewhere herein. Wrapper 10j is generally similar to wrapper 10i of FIG. 15 primarily in that wrapper 10j has an inner boundary 66j having a generally non-linear or irregular pattern. The wrapper 10j is constructed of a sheet of material 12j having a first surface 14j, a second surface 16j, and an outer peripheral edge 18j comprising a non-linear or irregular pattern as described elsewhere herein. The wrapper 10j further comprises a central decorative portion 32j and a peripheral decoration 34j having the inner boundary 66j located a length 68j inwardly from the outer peripheral edge 18j. The central decorative portion 32j occupies a generally central position on the first surface 14j of the sheet of material 12j inside the inner boundary 66j of the peripheral decoration 34j. The peripheral decoration 34j generally forms a complete border about the central decorative portion 32j.

The central decorative portion 32j has a width 44j extending thereacross generally across opposite portions of the inner boundary 66j of the peripheral decoration 34j. The peripheral decoration 34j also has a width 68j, extending between the outer peripheral edge 18j and the inner boundary 66j. The inner boundary 66j may be irregular, or non-linear (e.g., curved). When the inner boundary 66j is irregular, the point on the inner boundary 66j from which the width 68j is measured is that portion of the inner boundary 66j which extends the furthest into the central decorative portion 32j. The central decorative portion 32j is understood to comprise a decoration which is different from the peripheral decoration 34j, wherein the peripheral decoration 34j has the appearance of a sheet of material which is different from the sheet of material from which the wrapper 10j having the central decorative portion 32j is constructed, thereby giving the wrapper 10j a “two-sheet effect” as discussed elsewhere herein when formed about a pot, floral grouping or other item as described elsewhere herein, in a manner shown, for example for decorative cover 60h in FIG. 14.

When the wrapper 10j is constructed from a material having “dead-fold” properties, e.g., a metal foil, wherein the wrapper 10j readily holds its shape when folded or wrapper, it may not be necessary to secure the wrapper 10j about a pot with a securing element. The central decorative portion 32j and the peripheral decoration 34j may comprise any decorative effect, such as a color, texture, pattern, or design, as long as the central decorative portion 32j has a decorative effect which is different from the decorative effect of the peripheral decoration 34j in at least one manner. For example, the colors of the central decorative portion 32j and the peripheral decoration 34j may be the same, but the pattern or design printed thereon may be different. Alternatively, the pattern or design may be the same, but the colors may e different. Alternatively, the colors and patterns or designs may be the same, but the textures may be different, for example.

The width 68j of the peripheral decoration 34j is preferably from about 5% to about 50% of the width 44j of the central decorative portion 32j, more preferably from about 10% to about 40%, more preferably from about 15% to about 35% and, more preferably from about 20% to about 30%.

Shown in FIG. 17 and designated therein by the general reference numeral 10k is a wrapper for forming a decorative cover about a flower pot and/or a floral grouping, or other items as described above and elsewhere herein. Wrapper 10k is generally similar to wrapper 10 shown in FIG. 1 except for the differences described herein. The wrapper 10k is constructed of a sheet of material 12k having a first surface 14k, a second surface 16k, an outer peripheral edge 18k comprising a first edge 20k, a second edge 22k, a third edge 24k, and a fourth edge 26k, a first length 28k extending between first edge 20k and second edge 22k, and a second length 30k extending between the third edge 24k and the fourth edge 26k. The wrapper 10k further comprises a central decorative portion 32k and a peripheral decoration 34k comprising a first portion 36k and a second portion 38k. The central decorative portion 32k occupies a generally central position on the first surface 14k of the sheet of material 12k between the third edge 24k and the fourth edge 26k of the sheet of material 12k and the first portion 36k of the peripheral decoration 34k. The second portion 38k of the peripheral decoration 34k occupies a position adjacent the first edge 20k and between the third edge 24k, the fourth edge 26k, and a position adjacent the second edge 22k and between the third edge 24k and the fourth edge 24k.

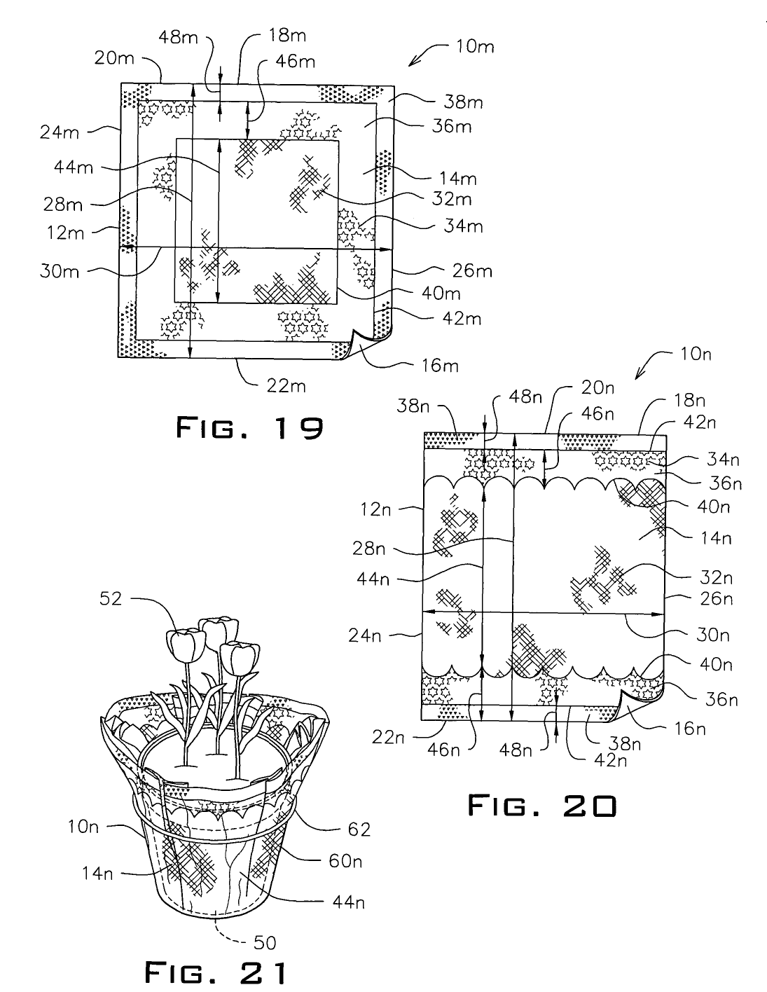

The first portion 36k of the peripheral decoration 34k occupies a position between the second portion 38k, third edge 24k, fourth edge 26k and central decorative portion 32k. The first portion 36k of the peripheral decoration 34k comprises a pair of first inner boundaries 40k which demarcate the first portion 36k of the peripheral decoration 34k from the central decorative portion 32k. The second portion 38k of the peripheral decoration 34k comprises a pair of second inner boundaries 42k which demarcate the second portion 38k of the peripheral decoration 34k from the first portion 36k of the peripheral decoration 34k. The first inner boundary 40k and second inner boundary 42k may have non-linear patterns. The central decorative portion 32k has a width 44k extending generally between the pair of first inner boundaries 40k. The first portion 36k of the peripheral decoration 34k has a width 46k, and the second portion 38k of the peripheral decoration 34k has a width 48k. The width 46k and width 48k are defined as the widest portions of the first portion 36k and second portion 38k, respectively. The central decorative portion 32k is understood to comprise a decoration which is at least partially different from the peripheral decoration 34k, wherein the peripheral decoration 34k has the appearance of a sheet of material which is at least partially different and separate from the sheet of material from which the wrapper 10k having the central decorative portion 32k is constructed, thereby giving the wrapper 10k a “two-sheet effect” or “three-sheet effect” as discussed elsewhere herein when formed as a decorative cover about a pot, floral grouping or other item as described elsewhere herein, and as shown for example in FIG. 18.

FIG. 18 shows the wrapper 10k formed about pot 50 and floral grouping 52 to provide a decorative cover 60k having a “three-sheet effect”, and secured about the pot 50 with a securing element 62. The first surface 14k of the wrapper 10k forms an outer surface 64k of the decorative cover 60k. When the wrapper 10k is constructed from a material having “dead-fold” properties, e.g., a metal foil, wherein the wrapper 10k readily holds its shape when folded or wrapped, it may not be necessary to secure the wrapper 10k about the pot 50 with a securing element 62. The central decorative portion 32k and the peripheral decoration 34k may comprise any decorative effect, such as a color, texture, pattern, or design, as long as the central decorative portion 32k has a decorative effect which is different from the decorative effect of at least one of first portion 36k or second portion 38k of the peripheral decoration 34k in at least one manner. For example, the colors of the central decorative portion 32k and the first and or second portions 30k and 38k of the peripheral decoration 34k may be the same, but the pattern or design printed thereon may be different. Alternatively, the pattern or design may be the same, but the colors may be different. Alternatively, the colors and patterns or designs may be the same, but the textures may be different, for example.

The width 46k of the first portion 36k of the peripheral decoration 34k and/or the width 48k of the second portion 38k of the peripheral decoration 34k are each preferably from about 5% to about 50% of the width 44k of the central decorative portion 32, more preferably from about 10% to about 40%, more preferably from about 15% to about 35% and, more preferably from about 20% to about 30%.

Shown in FIG. 19 and designated therein by the general reference numeral 10m is a wrapper for forming a decorative cover about a flower pot and/or a floral grouping, or other items as described above and elsewhere herein. Wrapper 10m is generally similar to wrapper 10k of FIG. 17 except wrapper 10m has a peripheral decoration 34m which forms a complete border on the wrapper 10m. The wrapper 10m is constructed of a sheet of material 12m having a first surface 14m, a second surface 16m, an outer peripheral edge 18m comprising a first edge 20m, a second edge 22m, a third edge 24m, and a fourth edge 26m, a first length 28m extending between first edge 20m and second edge 22m, and a second length 30m extending between the third edge 24m and the fourth edge 26m. The wrapper 10m further comprises a central decorative portion 32m and a peripheral decoration 34m. The peripheral decoration 34m comprises an inner portion 36m and an outer portion 38m, the outer portion 38m adjacent each of first, second, third and fourth edges 20m, 22m, 24m and 26m. The outer portion 38m has an inner boundary 42m located a width 48m inwardly from the outer peripheral edge 18m. The central decorative portion 32m occupies a generally central position on the first surface 14m of the sheet of material 12m inside an inner boundary 40m of the inner portion 36m of the peripheral decoration 34m. The inner portion 36m of the peripheral decoration 34m generally forms a complete border about the central decorative portion 32m, and within the second portion 38m of the peripheral decoration 34m.

The central decorative portion 32m has a width 44m extending thereacross generally across opposite portions of the inner boundary 40m of the inner portion 36m of the peripheral decoration 34m. The inner portion 36m of the peripheral decoration 34m also has a width 46m, extending between the central decorative portion 32m and the inner boundary 42m of the second portion 38m. The inner boundaries 40m and 42m may have irregular, or non-linear patterns. The central decorative portion 32m is understood to comprise a decoration which is different from at least one of inner portion 36m and outer portion 38m of the peripheral decoration 34m, wherein the peripheral decoration 34m has the appearance of sheets of material which are different from the sheet of material from which the wrapper 10m having the central decorative portion 32m is constructed, thereby giving the wrapper 10m a “two-sheet effect” or “three-sheet effect” as discussed elsewhere herein when formed about a pot, floral grouping or other item as described elsewhere herein, in a manner shown, for example for decorative cover 60k in FIG. 8.

When the wrapper 10m is constructed from a material having “dead-fold” properties, e.g., a metal foil, wherein the wrapper 10m readily holds its shape when folded or wrapped, it may not be necessary to secure the wrapper 10m about a pot with a securing element. The central decorative portion 32m and the peripheral decoration 34m may comprise any decorative effect, such as a color, texture, pattern, or design, as long as the central decorative portion 32m has a decorative effect which is different from the decorative effect at least one of inner portion 36m and outer portion 38m of the peripheral decoration 34m. For example, the colors of the central decorative portion 32m and the inner portion 36m and/or outer portion 38m of the peripheral decoration 34m may be the same, but the pattern or design printed thereon may be different. Alternatively, the pattern or design may be the same, but the colors may be different. Alternatively, the colors and patterns or designs may be the same, but the textures may be different, for example.

The width 46m of the first portion 36m and the width 48m of the second portion 38m of the peripheral decoration 34m is preferably from about 5% to about 50% of the width 44m of the central decorative portion 32m, more preferably from about 10% to about 40%, more preferably from about 15% to about 35% and, more preferably from about 20% to about 30%.

Shown in FIG. 20 and designated therein by the general reference numeral 10n is a wrapper for forming a decorative cover about a flower pot and/or a floral grouping, or other items as described above and elsewhere herein. Wrapper 10n is generally similar to wrapper 10k shown in FIG. 17 except for the differences described herein. The wrapper 10n is constructed of a sheet of material 12n having a first surface 14n, a second surface 16n, an outer peripheral edge 18n comprising a first edge 20n, a second edge 22n, a third edge 24n, and a fourth edge 26n, a first length 28n extending between first edge 20n and second edge 22n, and a second length 30n extending between the third edge 24n and the fourth edge 26n. The wrapper 10n further comprises a central decorative portion 32n and a peripheral decoration 34n comprising a first portion 36n and a second portion 38n. The central decorative portion 32n occupies a generally central position on the first surface 14n of the sheet of material 12n between the third edge 24n and the fourth edge 26n of the sheet of material 12n and the first portion 36n of the peripheral decoration 34n. The second portion 38n of the peripheral decoration 34n occupies a position adjacent the first edge 20n, and between the third edge 24n, the fourth edge 26n, and a position adjacent the second edge 22m and between the third edge 24m and the fourth edge 24m.

The first portion 36n of the peripheral decoration 34n occupies a position between the second portion 38n, third edge 24n, fourth edge 26n and central decorative portion 32n. The first portion 36n of the peripheral decoration 34n comprises a pair of first inner boundaries 40n which demarcate the first portion 36n of the peripheral decoration 34n from the central decorative portion 32n. The second portion 38n of the peripheral decoration 34n comprises a pair of second inner boundaries 42n which demarcate the second portion 38n of the peripheral decoration 34k from the first portion 36n of the peripheral decoration 34n. The pair of first inner boundary 40n are non-linear. The central decorative portion 32n has a width 44n extending generally between the pair of first inner boundaries 40n. The first portion 36n of the peripheral decoration 34n has a width 46n, and the second portion 38n of the peripheral decoration 34n has a width 48n. The width 46n and width 48n are defined as the widest portions of the first portion 36n and second portion 38n, respectively. The central decorative portion 32n is understood to comprise a decoration which is at least partially different from the peripheral decoration 34n, wherein the peripheral decoration 34n has the appearance of a sheet of material which is at least partially different and separate from the sheet of material from which the wrapper 10n having the central decorative portion 32n is constructed, thereby giving the wrapper 10n a “two-sheet effect” or “three-sheet effect” as discussed elsewhere herein when formed as a decorative cover about a pot, floral grouping or other item as described elsewhere herein, and as shown for example in FIG. 21.

FIG. 21 shows the wrapper 10n formed about pot 50 and floral grouping 52 to provide a decorative cover 60n having a “three-sheet effect”, and secured about the pot 50 with a securing element 62. The first surface 14n of the wrapper 10n forms an outer surface 64n of the decorative cover 60n. When the wrapper 10n is constructed from a material having “dead-fold” properties, e.g., a metal foil, wherein the wrapper 10n readily holds its shape when folded or wrapped, it may not be necessary to secure the wrapper 10n about the pot 50 with a securing element 62. The central decorative portion 32n and the peripheral decoration 34n may comprise any decorative effect, such as a color, texture, pattern, or design, as long as the central decorative portion 32n has a decorative effect which is different from the decorative effect of at least one of first portion 36n or second portion 38n of the peripheral decoration 34n in at least one manner. For example, the colors of the central decorative portion 32n and the first and/or second portions 30n and 38n of the peripheral decoration 34n may be the same, but the pattern or design printed thereon may be different. Alternatively, the pattern or design may be the same, but the colors may be different. Alternatively, the colors and patterns or designs may be the same, but the textures may be different, for example.

The width 46n of the first portion 36n of the peripheral decoration 34n and/or the width 48n of the second portion 38n of the peripheral decoration 34n are each preferably from about 5% to about 50% of the width 44n of the central decorative portion 32, more preferably from about 10% to about 40%, more preferably from about 15% to about 35% and, more preferably from about 20% to about 30%.

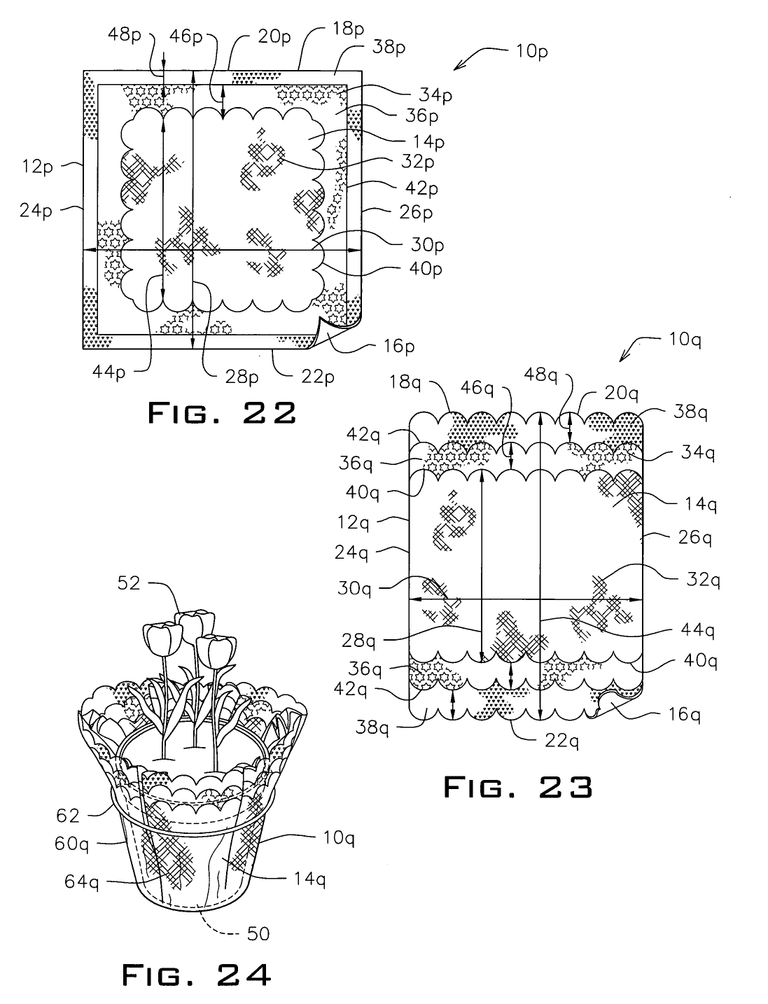

Shown in FIG. 22 and designated therein by the general reference numeral 10p is a wrapper for forming a decorative cover about a flower pot and/or a floral grouping, or other items as described above and elsewhere herein. Wrapper 10p is generally similar to wrapper 10n of FIG. 20 except wrapper 10p has a peripheral decoration 34p which forms a complete border on the wrapper 10p. The wrapper 10p is constructed of a sheet of material 12p having a first surface 14p, a second surface 16p, an outer peripheral edge 18p comprising a first edge 20p, a second edge 22p, a third edge 24p, and a fourth edge 26p, a first length 28p extending between first edge 20p and second edge 22p, and a second length 30p extending between the third edge 24p and the fourth edge 26p. The wrapper 10p further comprises a central decorative portion 32p and a peripheral decoration 34p. The peripheral decoration 34p comprises an inner portion 36p and an outer portion 38p, the outer portion 38p adjacent each of first, second, third and fourth edges 20p, 22p, 24p, and 26p. The outer portion 38p has an inner boundary 42p located a width 48p inwardly from the outer peripheral edge 18p. The central decorative portion 32p occupies a generally central position on the first surface 14p of the sheet of material 12p inside an inner boundary 40p of the inner portion 36p of the peripheral decoration 34p. The inner portion 36p of the peripheral decoration 34p generally forms a complete border about the central decorative portion 32p, and within the second portion 38p of the peripheral decoration 34p.

The central decorative portion 32p has a width 44p extending thereacross generally across opposite portions of the inner boundary 40p of the inner portion 36p of the peripheral decoration 34p. The inner portion 36p of the peripheral decoration 34p also has a width 46p, extending between the central decorative portion 32p and the inner boundary 42p of the second portion 38p. The inner boundaries 40p and 42p may have irregular, or non-linear patterns. The central decorative portion 32p is understood to comprise a decoration which is different from at least one of inner portion 36p and outer portion 38p of the peripheral decoration 34p, wherein the peripheral decoration 34p has the appearance of sheets of material which are different from the sheet of material from which the wrapper 10p having the central decorative portion 32p is constructed, thereby giving the wrapper 10p a “two-sheet effect” or “three-sheet effect” as discussed elsewhere herein when formed about a pot, floral grouping or other item as described elsewhere herein, in a manner shown, for example for decorative cover 60p in FIG. 21.

When the wrapper 10p is constructed from a material having “dead-fold” properties, e.g., a metal foil, wherein the wrapper 10p readily holds its shape when folded or wrapped, it may not be necessary to secure the wrapper 10p about a pot with a securing element. The central decorative portion 32p and the peripheral decoration 34p may comprise any decorative effect, such as a color, texture, pattern, or design, as long as the central decorative portion 32p has a decorative effect which is different from the decorative effect at least one of inner portion 36p and outer portion 38p of the peripheral decoration 34p. For example, the colors of the central decorative portion 32m and the inner portion 36p and/or outer portion 38p of the peripheral decoration 34p may be the same, but the pattern or design printed thereon may be different. Alternatively, the pattern or design may be the same, but the colors may be different. Alternatively, the colors and patterns or designs may be the same, but the textures may be different, for example.

The width 46p of the first portion 36p and the width 48p of the second portion 38p of the peripheral decoration 34p is preferably from about 5% to about 50% of the width 44p of the central decorative portion 32p, more preferably from about 10% to about 40%, more preferably from about 15% to about 35% and, more preferably from about 20% to about 30%.

Shown in FIG. 23 and designated therein by the general reference numeral 10q is a wrapper for forming a decorative cover about a flower pot and/or a floral grouping, or other items as described above and elsewhere herein. Wrapper 10q is generally similar to wrapper 10k shown in FIG. 17 except for the differences described herein. The wrapper 10q is constructed of a sheet of material 12q having a first surface 14q, a second surface 16q, an outer peripheral edge 18q comprising a first edge 20q, a second edge 22q, a third edge 24q, and a fourth edge 26q, a first length 28q extending between first edge 20q and second edge 22q, and a second length 30q extending between the third edge 24q and the fourth edge 26q. The wrapper 10q further comprises a central decorative portion 32q and a peripheral decoration 34q comprising a first portion 36q and a second portion 38q. The central decorative portion 32q occupies a generally central position on the first surface 14q of the sheet of material 12q between the third edge 24q and the fourth edge 26q of the sheet of material 12q and the first portion 36q of the peripheral decoration 34q. The second portion 38q of the peripheral decoration 34q occupies a position adjacent the first edge 20q, and between the third edge 24q, the fourth edge 26q, and a position adjacent the second edge 22q and between the third edge 24q and the fourth edge 24q. First edge 20q and second edge 22q each have non-linear or irregular shapes.

The first portion 36q of the peripheral decoration 34q occupies a position between the second portion 38q, third edge 24q, fourth edge 26q and central decorative portion 32q. The first portion 36q of the peripheral decoration 34q comprises a pair of first inner boundaries 40q which are non-linear or irregular and which demarcate the first portion 36q of the peripheral decoration 34q from the central decorative portion 32q. The second portion 38q of the peripheral decoration 34q comprises a pair of second inner boundaries 42q which are non-linear or irregular and which demarcate the second portion 38q of the peripheral decoration 34q from the first portion 36q of the peripheral decoration 34q. The first inner boundaries 40q and second inner boundaries 42q have non-linear patterns. The central decorative portion 32q has a width 44q extending generally between the pair of first inner boundaries 40q. The first portion 36q of the peripheral decoration 34q has a width 46q, and the second portion 38q of the peripheral decoration 34q has a width 48q. The width 46q and width 48q are defined as the widest portions of the first portion 36q and second portion 38q, respectively. The central decorative portion 32q is understood to comprise a decoration which is at least partially different from the peripheral decoration 34q, wherein the peripheral decoration 34q has the appearance of a sheet of material which is at least partially different and separate from the sheet of material from which the wrapper 10q having the central decorative portion 32q is constructed, thereby giving the wrapper 10q a “two-sheet effect” or “three-sheet effect” as discussed elsewhere herein when formed as a decorative cover about a pot, floral grouping or other item as described elsewhere herein, and as shown for example in FIG. 24.

FIG. 24 shows the wrapper 10q formed about pot 50 and floral grouping 52 to provide a decorative cover 60q having a “three-sheet effect”, and secured about the pot 50 with a securing element 62. The first surface 14q of the wrapper 10q forms an outer surface 64q of the decorative cover 60q. When the wrapper 10q is constructed from a material having “dead-fold” properties, e.g., a metal foil, wherein the wrapper 10q readily holds its shape when folded or wrapped, it may not be necessary to secure the wrapper 10q about the pot 50 with a securing element 62. The central decorative portion 32q and the peripheral decoration 34q may comprise any decorative effect, such as a color, texture, pattern, or design, as long as the central decorative portion 32q has a decorative effect which is different from the decorative effect of at least one of first portion 36q or second portion 38q of the peripheral decoration 34q in at least one manner. For example, the colors of the central decorative portion 32q and the first and or second portions 36q and 38q of the peripheral decoration 34q may be the same, but the pattern or design printed thereon may be different. Alternatively, the pattern or design may be the same, but the colors may be different. Alternatively, the colors and patterns or designs may be the same, but the textures may be different, for example.

The width 46q of the first portion 36q of the peripheral decoration 34q and/or the width 48q of the second portion 38q of the peripheral decoration 34q are each preferably from about 5% to about 50% of the width 44q of the central decorative portion 32, more preferably from about 10% to about 40%, more preferably from about 15% to about 35% and, more preferably from about 20% to about 30%.

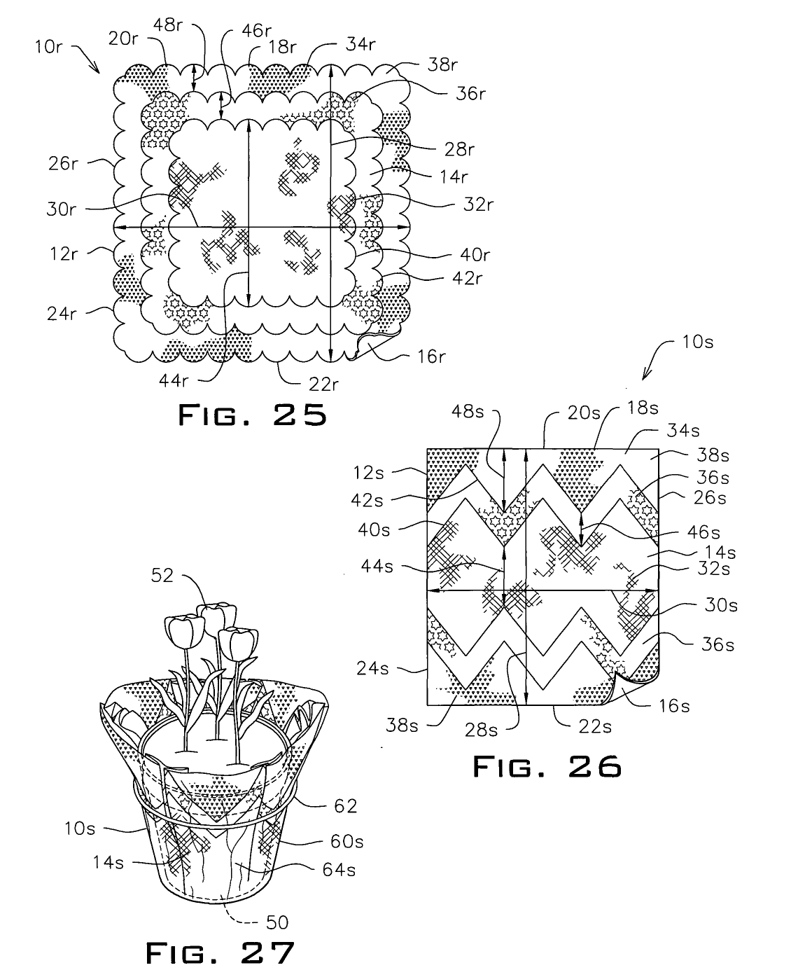

Shown in FIG. 25 and designated therein by the general reference numeral 10r is a wrapper for forming a decorative cover about a flower pot and/or a floral grouping, or other items as described above and elsewhere herein. Wrapper 10r is generally similar to wrapper 10q of FIG. 23 except wrapper 10r has a peripheral decoration 34r which forms complete border on the wrapper 10r. The wrapper 10r is constructed of a sheet of material 12r having a first surface 14r, a second surface 16r, an outer peripheral edge 18r comprising a first edge 20r, a second edge 22r, a third edge 24r, and a fourth edge 26r, a first length 28r extending between first edge 20r and second edge 22r, and a second length 30r extending between the third edge 24r and the fourth edge 26r. The wrapper 10r further comprises a central decorative portion 32r and a peripheral decoration 34r. The peripheral decoration 34r comprises an inner portion 36r and an outer portion 38r, the outer portion 38r adjacent each of first, second, third and fourth edges 20r, 22r, 24r, and 26r. The outer portion 38r has an inner boundary 42r located a width 48r inwardly from the outer peripheral edge 18r. The central decorative portion 32r occupies a generally central position on the first surface 14r of the sheet of material 12r inside an inner boundary 40r of the inner portion 36r of the peripheral decoration 34r. The inner portion 36r of the peripheral decoration 34r generally forms a complete border about the central decorative portion 32r, and within the second portion 38r of the peripheral decoration 34r.

The central decorative portion 32r has a width 44r extending thereacross generally across opposite portions of the inner boundary 40r of the inner portion 36r of the peripheral decoration 34r. The inner portion 36r of the peripheral decoration 34r also has a width 46r, extending between the central decorative portion 32r and the inner boundary 42r of the second portion 38r. The inner boundaries 40r and 42r have irregular, or non-linear patterns, as does the outer peripheral edge 18r. The central decorative portion 32r is understood to comprise a decoration which is different from at least one of inner portion 36r and outer portion 38r of the peripheral decoration 34r, wherein the peripheral decoration 34r has the appearance of sheets of material which are different from the sheet of material from which the wrapper 10r having the central decorative portion 32r is constructed, thereby giving the wrapper 10r a “two-sheet effect” or “three-sheet effect” as discussed elsewhere herein when formed about a pot, floral grouping or other item as described elsewhere herein, in a manner shown, for example for decorative cover 60q in FIG. 24.

When the wrapper 10r is constructed from a material having “dead-fold” properties, e.g., a metal foil, wherein the wrapper 10r readily holds its shape when folded or wrapped, it may not be necessary to secure the wrapper 10r about a pot with a securing element. The central decorative portion 32r and the peripheral decoration 34r may comprise any decorative effect, such as a color, texture, pattern, or design, as long as the central decorative portion 32r has a decorative effect which is different from the decorative effect at least one of inner portion 36r and outer portion 38r of the peripheral decoration 34r. For example, the colors of the central decorative portion 32r and the inner portion 36r and/or outer portion 38r of the peripheral decoration 34r may be the same, but the pattern or design printed thereon may be different. Alternatively, the pattern or design may be the same, but the colors may be different. Alternatively, the colors and patterns or designs may be the same, but the textures may be different, for example.

The width 46r of the first portion 36r and the width 48r of the second portion 38r of the peripheral decoration 34r is preferably from about 5% to about 50% of the width 44r of the central decorative portion 32r, more preferably from about 10% to about 40%, more preferably from about 15% to about 35% and, more preferably from about 20% to about 30%.

Shown in FIG. 26 and designated therein by the general reference numeral 10s is a wrapper for forming a decorative cover about a flower pot and/or a floral grouping, or other items as described above and elsewhere herein. Wrapper 10s is generally similar to wrapper 10k shown in FIG. 17 except for the differences described herein. The wrapper 10s is constructed of a sheet of material 12s having a first surface 14s, a second surface 16s, an outer peripheral edge 18s comprising a first edge 20s, a second edge 22s, a third edge 24s, and a fourth edge 26s, a first length 28s extending between first edge 20s and second edge 22s, and a second length 30s extending between the third edge 24s and the fourth edge 26s. The wrapper 10s further comprises a central decorative portion 32s and a peripheral decoration 34s comprising a first portion 36s and a second portion 38s. The central decorative portion 32s occupies a generally central position on the first surface 14s of the sheet of material 12s between the third edge 24s and the fourth edge 26s of the sheet of material 12s and the first portion 36s of the peripheral decoration 34s. The second portion 38s of the peripheral decoration 34s occupies a position adjacent the first edge 20s, and between the third edge 24s, the fourth edge 26s, and a position adjacent the second edge 22s and between the third edge 24s and the fourth edge 24s.

The first portion 36s of the peripheral decoration 34s occupies a position between the second portion 38s, third edge 24s, fourth edge 26s and central decorative portion 32s. The first portion 36s of the peripheral decoration 34s comprises a pair of first inner boundaries 40s which have an angular pattern and which demarcate the first portion 36s of the peripheral decoration 34s from the central decorative portion 32s. The second portion 38s of the peripheral decoration 34s comprises a pair of second inner boundaries 42s which have an angular pattern and which demarcate the second portion 38s of the peripheral decoration 34s from the first portion 36s of the peripheral decoration 34s. The central decorative portion 32s has a width 44s extending generally between the pair of first inner boundaries 40s. The first portion 36s of the peripheral decoration 34s has a width 46s, and the second portion 38s of the peripheral decoration 34s has a width 48s. The width 46s and width 48s are defined as the widest portions of the first portion 36s and second portion 38s, respectively. The central decorative portion 32s is understood to comprise a decoration which is at least partially different from the peripheral decoration 34s, wherein the peripheral decoration 34s has the appearance of a sheet of material which is at least partially different and separate from the sheet of material from which the wrapper 10s having the central decorative portion 32s is constructed, thereby giving the wrapper 10s a “two-sheet effect” or “three-sheet effect” as discussed elsewhere herein when formed as a decorative cover about a pot, floral grouping or other item as described elsewhere herein, and as shown for example in FIG. 27.

FIG. 27 shows the wrapper 10s formed about pot 50 and floral grouping 52 to provide a decorative cover 60s having a “three-sheet effect”, and secured about the pot 50 with a securing element 62. The first surface 14s of the wrapper 10s forms, an outer surface 64s of the decorative cover 60s. When the wrapper 10s is constructed from a material having “dead-fold” properties, e.g., a metal foil, wherein the wrapper 10s readily holds its shape when folded or wrapped, it may not be necessary to secure the wrapper 10s about the pot 50 with a securing element 62. The central decorative portion 32s and the peripheral decoration 34s may comprise any decorative effect, such as a color, texture, pattern, or design, as long as the central decorative portion 32s has a decorative effect which is different from the decorative effect of at least one of first portion 36s or second portion 38s of the peripheral decoration 34s in at least one manner. For example, the colors of the central decorative portion 32s and the first and/or second portions 36s and 38s of the peripheral decoration 34s may be the same, but the pattern or design printed thereon may be different. Alternatively, the pattern or design may be the same, but the colors may be different. Alternatively, the colors and patterns or designs may be the same, but the textures may be different, for example.

The width 46s of the first portion 36s of the peripheral decoration 34s and/or the width 48s of the second portion 38s of the peripheral decoration 34s are each preferably from about 5% to about 50% of the width 44s of the central decorative portion 32, more preferably from about 10% to about 40%, more preferably from about 15% to about 35% and, more preferably from about 20% to about 30%.

Shown in FIG. 28 and designated therein by the general reference numeral 10t is a wrapper for forming a decorative cover about a flower pot and/or a floral grouping, or other items as described above and elsewhere herein. Wrapper 10t is generally similar to wrapper 10s of FIG. 26 except 10t has a peripheral decoration 34t which forms a complete border on the wrapper 20t. The wrapper 10t is constructed of a sheet of material 12t having a first surface 14t, a second surface 16t, an outer peripheral edge 18t comprising a first edge 20t, a second edge 22t, a third edge 24t, and a fourth edge 26t, a first length 28t extending between first edge 20t and second edge 22t, and a second length 30t extending between the third edge 24t and the fourth edge 26t. The wrapper 10t further comprises a central decorative portion 32t and a peripheral decoration 34t. The peripheral decoration 34t comprises an inner portion 36t and an outer portion 38t, the outer portion 38t adjacent each of first, second, third and fourth edges 20t, 22t, 24t and 26t. The outer portion 38t has an inner boundary 42t located a width 48t inwardly from the outer peripheral edge 18t. The central decorative portion 32t occupies a generally central position on the first surface 14t of the sheet of material 12t inside an inner boundary 40t of the inner portion 36t of the peripheral decoration 34t. The inner portion 36t of the peripheral decoration 34t generally forms a complete border about the central decorative portion 32t, and within the second portion 38t of the peripheral decoration 34t.

The central decorative portion 32t has a width 44t extending thereacross generally across opposite portions of the inner boundary 40t of the inner portion 36t of the peripheral decoration 34t. The inner portion 36t of the peripheral decoration 34t also has a width 46t, extending between the central decorative portion 32t and the inner boundary 42t of the second portion 38t. The inner boundaries 40t and 42t comprise angular patterns. The central decorative portion 32t is understood to comprise a decoration which is different from at least one of inner portion 36t and outer portion 38t of the peripheral decoration 34t, wherein the peripheral decoration 34t has the appearance of sheet of material which are different from the sheet of material from which the wrapper 10t having the central decorative portion 32t is constructed, thereby giving the wrapper 10t a “two-sheet effect” or “three-sheet effect” as discussed elsewhere herein when formed about a pot, floral grouping or other item as described elsewhere herein, in a manner shown, for example for decorative cover 60t in FIG. 27.

When the wrapper 10t is constructed from a material having “dead-fold” properties, e.g., a metal foil, wherein the wrapper 10t readily holds its shape when folded or wrapped, it may not be necessary to secure the wrapper 10t about a pot with a securing element. The central decorative portion 32t and the peripheral decoration 34t may comprise any decorative effect, such as a color, texture, pattern, or design, as long as the central decorative portion 32t has a decorative effect which is different from the decorative effect at least one of inner portion 36t and outer portion 38t of the peripheral decoration 34t. For example, the colors of the central decorative portion 32t and the inner portion 36t and/or outer portion 38t of the peripheral decoration 34t may be the same, but the pattern or design printed thereon may be different. Alternatively, the pattern or design may be the same, but the colors may be different. Alternatively, the colors and patterns or designs may be the same, but the textures may be different, for example.

The width 46t of the first portion 36t and the width 48t of the second portion 38t of the peripheral decoration 34t is preferably from about 5% to about 50% of the width 44t of the central decorative portion 32t, more preferably from about 10% to about 40%, more preferably from about 15% to about 35% and, more preferably from about 20% to about 30%.

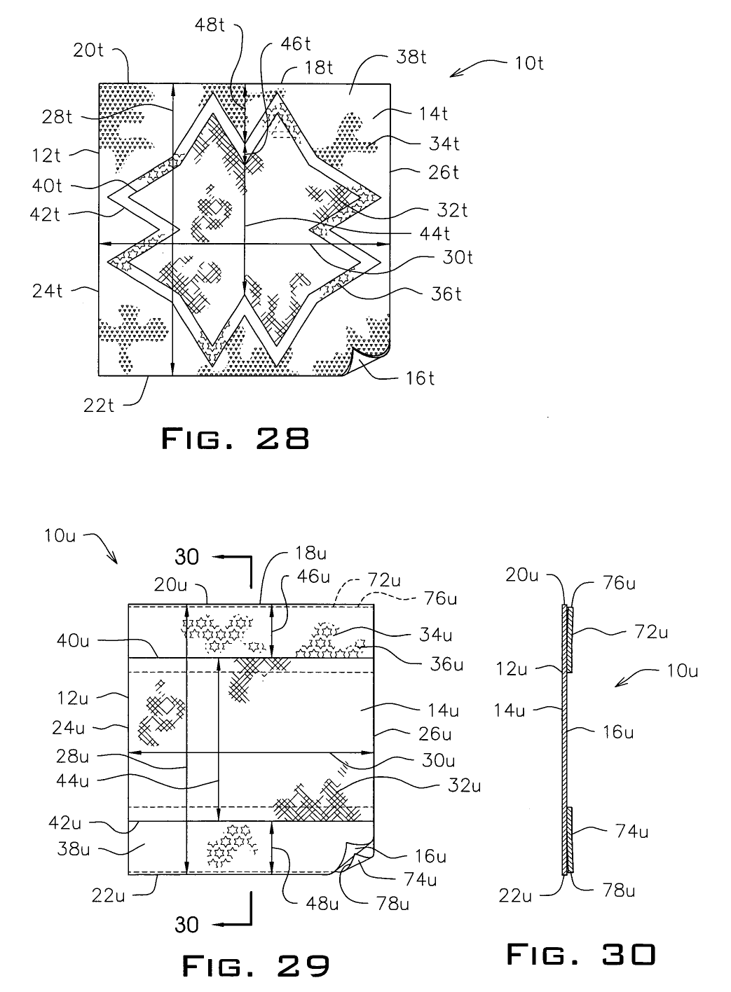

Shown in FIGS. 29 and 30 and designated therein by the general reference numeral 10u is a wrapper for forming a decorative cover about a flower pot and/or a floral grouping, or other items as described above and elsewhere herein. The wrapper 10u is similar to wrapper 10 as shown in FIG. 1 except for the differences described herein. The wrapper 10u is constructed of a sheet of material 12u having a first surface 14u, a second surface 16u, an outer peripheral edge 18u comprising a first edge 20u, a second edge 22u, a third edge 24u, and a fourth edge 46u, a first length 28u extending between first edge 20u and second edge 22u, and a second length 30u extending between the third edge 24u and the fourth edge 26u. The wrapper 10 further comprises a central decorative portion 32u and a peripheral decoration 34u comprising a first portion 36u and a second portion 38u. The central decorative portion 32u occupies a generally central position on the first surface 14u of the sheet of material 12u between the third edge 24u and the fourth edge 26u of the sheet of material 12u and the peripheral decoration 34u. The first portion 36u of the peripheral decoration 34u occupies a position between the first edge 20u, the third edge 24u, the fourth edge 26u, and the central decoration portion 32u.

The second portion 38u of the peripheral decoration 34u occupies a position between the second edge 22u, third edge 24u, fourth edge 26u and central decorative portion 32u. The first portion 36u of the peripheral decoration 34u comprises a first inner boundary 40u which demarcates the first portion 36u of the peripheral decoration 34u from the central decorative portion 32u. The second portion 38u of the peripheral decoration 34u comprises a second inner boundary 42u which demarcates the second portion 38u of the peripheral decoration 34u from the central decorative portion 32u. The central decorative portion 32u has a width 44u extending generally between the first inner boundary 40u and the second inner boundary 42u. The first portion 36u of the peripheral decoration 34u has a width 46u, and the second portion 38u of the peripheral decoration 34u has a width 48u. Since the first inner boundary 40u and second inner boundary 42u may comprise an edge of a printed pattern, the first inner boundary 40u and second inner boundary 42u may be irregular, non-linear, curved or rather than straight. When the first inner boundary 40u and/or the second inner boundary 42u are non-linear or irregular, the point on the first inner boundary 40u or second inner boundary 42u from which the width 46u and width 48u are measured will be considered to be those portions of the first inner boundary 40u and second inner boundary 42u which extend the furthest into the central decorative portion 32u. The central decorative portion 32u is understood to comprise a decoration which is different from the peripheral decoration 34r, wherein the peripheral decoration 34u has the appearance of a sheet of material which is different and separate from the sheet of material from which the wrapper 10u having the central decorative portion 32u is constructed. Any one or all of the outer peripheral edge 18u, first inner boundary 40u, second inner boundary 42u, or first, second, third or fourth edges 20u, 22u, 24u, or 26u may comprise a linear, non-linear, or irregular pattern.

Wrapper 10u further comprises a first extension 72u and a second extension 74u. First extension 72u is attached to a portion of the second surface 16u generally adjacent the first portion 36u of the peripheral decoration 34u. The first extension 72u has an outer edge 76u which may extend past, be flush with, or be below first edge 20u. The second extension 74u is attached to a portion of the second surface 16u generally adjacent the second portion 38u of the peripheral decoration 34u, and has an outer edge 78u which may extend past, be flush with, or be below second edge 22u. In an alternative embodiment (not shown), extensions may be attached to and extend from portions of the sheet of material 12u adjacent third edge 24u and/or fourth edge 26u. Further, wrapper 10u may be constructed such that first and second extensions 72u and 74u are attached to the first surface 14u rather than to the second surface 16u. The combination of the central decorative portion 32u with the peripheral decoration 34u and the first and second extensions 72u and 74u are intended to provide a “two-sheet” or “three-sheet” effect when the wrapper 10u is disposed about pot 50 or other item to provide a decorative cover 60u as shown in FIG. 31. Decorative cover 60u is secured about the pot 50 and floral grouping 52 with a securing element 62 and has an outer surface 64u derived from the front surface 14u. Preferably each of the central decorative portion 32u and peripheral decoration 34u has a decoration, color, pattern, texture or design which is different from first and second extensions 72u and 74u, or only one of the central decorative portion 32u or peripheral decoration 34u may be different from the first and second extensions 72u and 74u. And, in fact, any of the wrappers described or enabled herein may be equipped with extensions as described herein.

When the wrapper 10u is constructed from a sheet of material 12u having “dead-fold” properties, e.g., a metal foil, wherein the wrapper 10 readily holds its shape when folded or wrapped, it may not be necessary to secure the wrapper 10u about the pot 50 with a securing element 62. The central decorative portion 32u and the peripheral decoration 34u and first and second extensions 72u and 74u may comprise any decorative effect, such as a color, texture, pattern, or design, as long as the central decorative portion 32u has a decorative effect which is different from the decorative effect of the peripheral decoration 34u and/or first and second extensions 72u and 74u in at least one manner. For example, the colors of the central decorative portion 32u and the peripheral decoration 34u may be the same, but the pattern or design printed thereon may be different. Alternatively, the pattern or design may be the same, but the colors may be different. Alternatively, the colors and patterns or designs may be the same, but the textures may be different, for example.

The width 46u of the first portion 36u of the peripheral decoration 34u and the width 48u of the second portion 38u of the peripheral decoration 34u and widths of the first and second extensions 72u and 74u are each preferably from about 5% to about 50% of the width 44u of the central decorative portion 32u, more preferably from about 10% to about 40%, more preferably from about 15% to about 35% and, more preferably from about 20% to about 30%.

It will be understood however by one of ordinary skill in the art that the decorative wrappers described herein may comprise any other pattern thereon, or may not have a pattern, but may only be differently textured or colored. For example, the central decorative portion may be opaque and have a color, decoration, or texture (or all of these, for example) while the peripheral decoration is decorated yet is transparent. Any image disposed on the wrappers or any portion thereof or any other may be die cut or printed thereon or die cut or printed in register thereon.

The decorative wrappers described herein may be supplied in a stack of individual wrappers, in a pad wherein the wrappers are attached together, or in a roll, wherein individual wrappers are separated from the roll via perforations preplaced into the webbing of the roll, or by separation via a cutting or shearing implement, or in a pad of separate wrappers which is rolled about a stiff cylinder (such as cardboard) for easy removal. Any of the wrappers described herein may have a hole, slot, or perforations, therein (not shown) for insertion of the stem or stems of a floral grouping for enabling the wrapper to be wrapped about a floral grouping without a pot. The hole, slot, or perforations may be located in any portion of the sheet of material but preferably are located in a centrally disposed portion thereof or may be offset from the center.

Although the edges of the decorative wrappers shown herein generally have a straight or curved (non-linear) pattern, it will be understood that the edges may have any non-linear pattern, such as a geometric pattern, for example, sine wave, arced, toothed, angular, crenelate, crenate, crenulate, scalloped, starred, or may have a combination of a linear and non-linear pattern or an irregular pattern. The edges, central decorative portions and/or peripheral decorations described herein may have a biomorphic shape such as a face, animal, flower, rabbit, Santa Claus, egg, or other image printed thereon or present as a shape within the edges.

In one embodiment, the present invention contemplates a method of providing a decorative cover for an item such as a potted plant, floral grouping, or other item described or contemplated herein wherein the method comprises providing one or more of any of the wrappers described herein, and selling and delivering the wrapper to a producer or seller of items for producing a decoratively covered item by the producer or seller, wherein the decoratively covered item is capable of being produced by wrapping a single (or more than one) wrapper about the item and securing the single (or more than one) wrapper in place about the item via a securing element as described elsewhere herein (or by simply forming the wrapper about the item if the wrapper is formed from a deadfold material wherein the wrapper is not necessarily secured about the item by a separate securing element) thereby providing the decorative cover about the item and wherein the decoratively covered item able to be so produced has an appearance of an item wrapped by at least two separate sheets of material (a “two-sheet effect”).

The sheet of material of any of the decorative wrappers described herein may be constructed to have any effective or decorative shape, such as a square, a rectangle, a polygon, a circle, an oval, a triangle, star, or other shape as long as the decorative wrapper has a peripheral decoration and a central decorative portion. For example the sheet of material may have a sine wave, scalloped, toothed, or other shape comprising its border.

Further, as noted above, the decorative effect may comprise biomorphic shapes such as “bunny rabbit” shapes, or “leaf” type shapes therein. These represent but two examples of biomorphic shapes which the decoration of the decorative wrappers described herein may comprise.

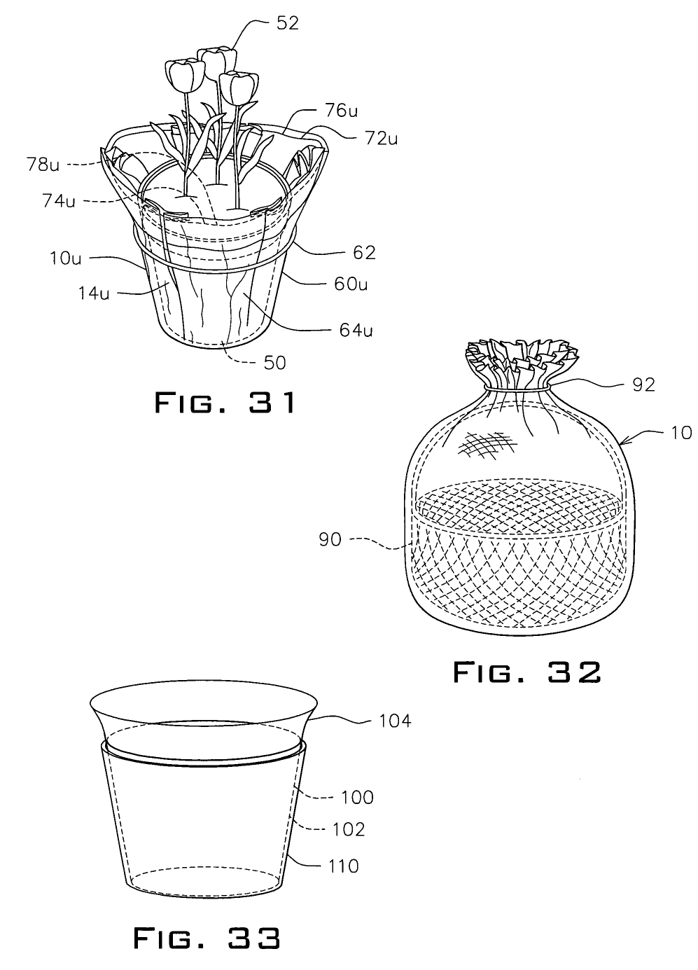

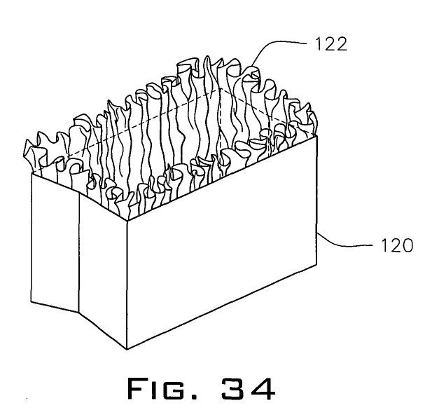

Referring now to FIG. 32, shown therein is a wrapper 10, previously described, which has been used as a basket wrapper to cover a basket 90. The wrapper 10 is preferably secured about the basket 90 via a securing element 92, similar to securing element 62 described previously.

Shown in FIG. 33 and designated therein by reference numeral 100 is a liner having a lower decorative base 102 and an upper peripheral decoration 104. The liner 100 is constructed in a manner similar to the decorative wrappers 10-10u described elsewhere herein but is used as a liner for a basket 110 or other container such as a gift can, pot, box, or bag, rather than as a decorative cover for an item.

Shown in FIG. 34 is a sack, bag, basket, box, or other container designated by reference numeral 120 which is used to contain items such as gift items, fruit, nuts, Easter eggs, or the like. A filler material 122 is disposed within the container 120 to decorate, cushion, or fill the container with the item therein. The filler 122 comprises entire wrappers (or portions or strips thereof) such as decorative wrappers 10-10u described elsewhere herein.

Any of the decorative wrappers described herein may be secured about a pot, or potted plant, or floral grouping or other item contemplated herein via a securing element 62 defined herein as including, but not limited to, devices such as a rubber band, elastic band, non-elastic band, string, ribbon, wire or plastic tie, shrink films or materials (e.g., heat shrink, chemical shrink, or moisture-shrink film), collar, sleeve, tape, label, stribbon, stretch film, metal strip, overpot, jardiniere overpot, Speed Cover™, or any other banding device known to those of ordinary skill in the art. The securing element 62, when used, may be positioned below or above an upper end of the item wrapped by the decorative wrapper 10-10u. More than one securing element 62 can be used. The securing element 62 may be applied manually or automatically. The securing element 62 preferably is a banding element but may also be an adhesive or cohesive material, barbs or slots on the pot, pins, clips, springs, staples, magnets, heat seals, chemical seals, vibratory seals or any other binding or securing materials known in the art. The securing element 62 can be attached to the sheet of material and/or extension, or initially can be separate from the sheet of material or extension.

The decorative wrappers described herein, including decorative wrappers 10-10u, can be constructed, in whole or in part, from materials including, but not limited to, polymer films, metallized polymer films, natural films, metallized natural films, printed materials of any type, matted materials of any type, cloth, fabric, spun bonded or melt blown materials, cling or “cling-type” materials, paper, tissue, cellophane, biodegradable materials, recyclable materials, and deadfold materials including metal foils and polyfoil. The materials may have a “cloth-like” or “paper-like” appearance. The materials may be embossed. The material may be waterproof. The sheet of material may have different colors, patterns, or textures. In one embodiment, the decorative wrapper may be constructed of a polymer film which has been printed to have the appearance of a spun-bonded or melt-blown material. Other materials and methods of providing a material with a decorative appearance will readily come to the mind of the person of ordinary skill in the art.

The materials from which the decorative wrappers shown or described herein are constructed preferably have a thickness in a range from about 0.1 mil to about 30 mils. Often, the thicknesses of the decorative wrappers are in a range from about 0.5 mil to about 10 mils or preferably, in a range from about 1.0 mil to about 5 mils. Preferably, the decorative wrappers are constructed from a material which is flexible, semi-rigid, rigid, or any combination thereof. The decorative wrappers may be constructed of a single layer of material or a plurality of layers of the same or different types of materials. Any thickness of the material may be utilized as long as the material functions in accordance with the present invention as described herein. Any thickness of material may be utilized in accordance with the present invention as long as the decorative wrapper may be formed as described herein, and as long as the wrapper may contain at least a portion of a flower pot, potted plant, growing medium or floral grouping or other item, as described herein.

As noted above, the decorative wrappers shown or described herein may be constructed from any suitable material that is capable of being formed into a wrapper as contemplated herein and wrapped about a flower pot and/or a floral grouping or item disposed therein. Preferably, the materials include treated or untreated paper, metal foil including deadfold materials, polymeric film, non-polymeric film woven, or nonwoven fabric, or synthetic or natural fabric, cardboard, fiber, cloth, burlap, or laminations or combinations thereof. As previously noted, the material comprising the extension is preferably not a “cling”-type self-adhering film. Preferably, the material used to construct the sheet of material of the wrapper is a waterproof material such as BOPP (biaxially oriented polypropylene) or metallized BOPP, or is substantially waterproof or water resistant.

The term “polymeric film” when used herein means a film made of a synthetic polymer such as a polypropylene or a naturally occurring polymer such as cellophane. A polymeric film is relatively strong and not as subject to tearing (substantially non-tearable), as might be the case with paper or foil.

The materials comprising the decorative wrappers shown or described herein may vary in color and as described herein consists of designs or decorative patterns which are printed, etched, and/or embossed thereon using inks or other printing materials. An example of an ink which may be applied to the surface of the material is described in U.S. Pat. No. 5,147,706, which is hereby expressly incorporated herein by reference.

In addition, the materials may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination in the material. Moreover, portions of the materials used in constructing the decorative wrappers shown or described herein may vary in the combination of such characteristics. The materials utilized in the decorative wrappers may be opaque, translucent, transparent, or partially clear or tinted transparent. The wrapper may have a low-slip (non-slip) material thereon which imparts a “frictional” quality to the wrapper. The non-slip coating may have a high coefficient of friction and may be disposed on either surface of the wrapper. The coating may be a lacquer. The low-or non-slip material preferably reduces the tendency of the wrapper to slip or slide off the pot or the securing element to slide or slip downwardly.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping preferably comprises a bloom or foliage portion and a stem portion and may comprise roots. Further, the floral grouping may be the plant portion of a potted plant. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule”.

The term “growing medium” or “retaining medium” when used herein means any liquid, solid or gaseous material used for plant growth or for the cultivation of propagules, including organic and inorganic materials such as soil, humus, perlite, vermiculite, sand, water, foam, and including the nutrients, fertilizers or hormones or combinations thereof required by the plants or propagules for growth or any material effective in supporting a plant, cutting, or floral grouping.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet of floral grouping. The term “propagule” when used herein means any structure capable of being propagated or acting as an agent of reproduction including seeds, shoots, stems, runners, tubers, plants, leaves, roots, or spores.

In accordance with the present invention and as noted earlier, a bonding material may optionally be disposed on a portion of any of the decorative wrappers shown or described herein to attach each decorative wrapper to a flower pot or other item or to assist in closing or sealing an upper portion of the wrapper, respectively, or in adhering the wrapper to the pot or other item.

As noted elsewhere herein, the decorative wrapper contemplated herein may comprise portions which are detachable via a detaching element. The term “detaching element” where used herein means any element or device such as, but not limited to, perforations, tear strips, zippers, and any other devices or elements of this nature known in the art, or any combination thereof, which enable the tearing away or detachment of one object from another.

The term “flower pot” or “pot” as used herein refers to any type of container used for holding a floral grouping or plant, including vases. Examples of pots, used in accordance with the present invention include, but are not limited to, clay pots, foam pots, wooden pots, plastic pots, pots made from natural and/or synthetic fibers (such as peat moss), and/or any combination thereof. The flower pot is adapted to receive a floral grouping in the retaining space thereof. The floral grouping may be disposed within the flower pot along with a suitable growing medium described elsewhere herein, or other retaining medium, such as a floral foam.

Preferably the decorative wrappers shown or described herein are sized to contain and conform to at least one of a variety of standard sizes of pots known to those of ordinary skill in the art, such as 3½ inch, 4 inch, 4 ½ inch, 5 inch, 5½ inch, 6 inch, 6½ inch, 7 inch, 7½ inch, 8 inch and 8½ inch pots or pots that are larger than, smaller than, or intermediate between such pot sizes such that preferably when the decorative wrapper is applied about the pot a skirt portion is formed as described earlier which is positioned near the upper rim of the pot.

Changes may be made in the construction and the operation of the various components, elements and assemblies described herein or in the steps or the sequence of steps of the methods described herein without departing from the spirit and scope of the invention as defined in the following claims.

What is claimed is:

1. A method of wrapping an item, comprising:
providing a decorative wrapper comprising a sheet of material having a first surface, a second surface, an outer peripheral edge, a central decorative portion of the first surface, and a peripheral decoration of the first surface adjacent at least a portion of the outer peripheral edge, the peripheral decoration having at least an inner boundary which forms an interface between the peripheral decoration and the central decorative portion and wherein the central decorative portion has a width which is greater than a maximum width of the peripheral decoration, and wherein the peripheral decoration has a decorative pattern or effect which is different from a decorative pattern or effect of the central decorative portion; and
placing the decorative wrapper about an item thereby forming a decorative cover about the item, the decorative wrapper placed abut the item in a position wherein the first surface of the decorative wrapper is outwardly exposed to form an outer surface of the decorative cover and wherein the peripheral decoration of the decorative wrapper is disposed in a position generally above the central decorative portion, and wherein due to the difference between the decorative pattern or effect of the peripheral decoration and the decorative pattern or effect of the central decorative portion, the decorative cover has an appearance of being constructed from at least two separate sheets of material.

2. The method of claim 1 wherein in the step of providing a decorative wrapper, the outer peripheral edge of the decorative wrapper is non-linear or irregular.

3. The method of claim 1 wherein in the step of providing a decorative wrapper, the outer peripheral edge of the decorative wrapper is linear.

4. The method of claim 1 wherein in the step of providing a decorative wrapper, the inner boundary of the peripheral decoration has a non-linear or irregular pattern.

5. The method of claim 1 wherein in the step of providing a decorative wrapper, the inner boundary of the peripheral decoration has a linear pattern.

6. The method of claim 1 wherein in the step of providing a decorative wrapper, the maximum width of the peripheral decoration is 5% to 50% of the width of the central decorative portion.

7. The method of claim 1 comprising the additional step of securing the decorative cover about the item via a securing element.

8. The method of claim 1 wherein in the step of providing a decorative wrapper, the decorative wrapper further comprises a decorative extension attached to a portion of the sheet of material near the peripheral decoration and having an outer edge positioned below, flush with, or beyond at least a portion of the outer peripheral edge of the sheet of material.

9. The method of claim 1 wherein in the step of providing a decorative wrapper, the decorative wrapper further comprises an adhesive bonding material or non-slip material disposed upon a portion thereof.

10. The method of claim 1 wherein in the step of providing a decorative wrapper, the sheet of material of the decorative wrapper is rectangular.

11. The method of claim 1 wherein in the step of providing a decorative wrapper, the sheet of material of the decorative wrapper is circular.

12. The method of claim 1 wherein in the step of placing the decorative wrapper about an item, the item is a potted plant.

13. The method of claim 1 wherein in the step of placing the decorative wrapper about an item, the item is a floral grouping.

14. The method of claim 1 wherein in the step of placing the decorative wrapper about an item, the item is a basket.

15. The method of claim 1 wherein in the step of placing the decorative wrapper about an item, the item is a gift item.

16. The method of claim 1 wherein in the step of placing the decorative wrapper about an item, the item comprises candy, nuts, fruit, vegetables, bulbs, or comestibles.

17. A method of providing a decorative cover for an item, comprising:
providing a decorative wrapper comprising:
a sheet of material having a first surface, a second surface, an outer peripheral edge, a central decorative portion of the first surface, and a peripheral decoration of the first surface adjacent at least a portion of the outer peripheral edge, the peripheral decoration having an inner boundary which forms an interface between the peripheral decoration and the central decorative portion and wherein the central decorative portion has a width which is greater than a maximum width of the peripheral decoration, and wherein the peripheral decoration has a decorative pattern or effect which is different from a decorative pattern or effect of the central decorative portion; and
selling and delivering the decorative wrapper to a producer or seller of items for producing a decoratively covered item by the producer or seller, wherein the decoratively covered item is capable of being produced by wrapping a single decorative wrapper about the item and securing the single decorative wrapper in place about the item via a securing element thereby providing the decorative cover about the item and wherein, due to the difference between the decorative pattern or effect of the peripheral decoration and the decorative pattern or effect of the central decorative portion, the decoratively covered item able to be so produced has an appearance of an item wrapped by at least two separate sheets of material.

18. The method of claim 17 wherein in the step of providing a decorative wrapper, the outer peripheral edge of the decorative wrapper is non-linear or irregular.

19. The method of claim 17 wherein in the step of providing a decorative wrapper, the outer peripheral edge of the decorative wrapper is linear.

20. The method of claim 17 wherein in the step of providing a decorative wrapper, the inner boundary of the peripheral decoration has a non-linear or irregular pattern.

21. The method of claim 17 wherein in the step of providing a decorative wrapper, the inner boundary of the peripheral decoration has a linear pattern.

22. The method of claim 17 wherein in the step of providing a decorative wrapper, the maximum width of the peripheral decoration is 5% to 50% of the width of the central decorative portion.

23. The method of claim 17 wherein in the step of providing a decorative wrapper, the decorative wrapper further comprises a decorative extension attached to a portion of the sheet of material near the peripheral decoration and having an outer edge positioned below, flush with, or beyond at least a portion of the outer peripheral edge of the sheet of material.

24. The method of claim 17 wherein in the step of providing a decorative wrapper, the decorative wrapper further comprises an adhesive bonding material or non-slip material disposed upon a portion thereof.

25. The method of claim 17 wherein in the step of providing a decorative wrapper, the sheet of material of the decorative wrapper is rectangular.

26. The method of claim 17 wherein in the step of providing a decorative wrapper, the sheet of material of the decorative wrapper is circular.

27. The method of claim 17 wherein the item about which the decorative wrapper may be wrapped is a potted plant.

28. The method of claim 17 wherein the item about which the decorative wrapper may be wrapped is a floral grouping.

29. The method of claim 17 wherein the item about which the decorative wrapper may be wrapped is a basket.

30. The method of claim 17 wherein the item about which the decorative wrapper may be wrapped is a gift item.

31. The method of claim 17 wherein the item about which the decorative wrapper may be wrapped comprises candy, fruit, nuts, vegetables, bulbs, or comestibles.
